(19) United States
(12) Patent Application Publication
(10) Pub. No.: US 2024/0412906 A1
(43) Pub. Date: Dec. 12, 2024

(54) A ferromagnetic powder composition and the method for obtaining thereof

(71) Applicant: Höganäs AB, HÖGANÄS (SE)

(72) Inventors: Ye ZHOU, Lerberget (SE); Björn SKÅRMAN, Höganäs (SE); Christian JÖNSSON, Malmö (SE); Benjamin BRASH, Växjö (SE); Ann-Cathrin HELLSÉN, Höganäs (SE)

(21) Appl. No.: 18/699,971

(22) PCT Filed: Oct. 17, 2022
(86) PCT No.: PCT/EP2022/078826

§ 371 Date: Apr. 10, 2024

(30) Foreign Application Priority Data
Oct. 15, 2021 (EP) 21202965.6

(51) Int. Cl. H01F 1/33; H01F 1/26

(52) U.S. Cl. CPC H01F 1/33; H01F 1/26

(57) ABSTRACT

A ferromagnetic powder composition including soft magnetic iron based core particles, wherein the average size of the core particles is in the range 20-1000 μm, wherein the surface of the core particles is at least partially coated with an at least partially covering first coating including at least one silicate of the general formula (M₂O)_{α}(SiO₂)_{β}, wherein α is moles of M₂O, β is moles of SiO₂, and the β/α molar ratio is in the interval from 0.5 to 4.1, wherein the first coating is in direct contact with a surface of the core particles of the ferromagnetic powder, and wherein the silicate is present in the amount of ferromagnetic powder composition comprises 0.02 to 1.0 wt % of at least one silicate calculated based on the total weight of the ferromagnetic powder composition. There is further provided a method for coating the soft-magnetic iron-based core particles and manufacturing of parts.

### TECHNICAL FIELD

The present invention relates to a ferromagnetic powder composition comprising soft magnetic iron-based core particles as well as a method for manufacturing it.

### BACKGROUND

Soft magnetic composite (SMC) powders are known in the art and are based on soft magnetic core particles, usually iron-based, with an electrically insulative coating on each particle. The SMC components are obtained by compacting the insulated particles using known powder metallurgical compaction processes, typically together with lubricants and/or known binders.

Two key characteristics of an iron core component are its magnetic permeability and core loss characteristics. The magnetic permeability of a material is an indication of its ability to become magnetized or its ability to carry a magnetic flux. Permeability is defined as the ratio of the induced magnetic flux to the magnetizing force or field intensity. When a magnetic material is exposed to a varying field, energy losses occur due to both hysteresis losses and eddy current losses. The hysteresis loss (DC-loss), which constitutes most of the total core losses in most motor applications, is brought about by the necessary expenditure of energy to overcome the retained magnetic forces within the iron core component. The forces can be minimized by improving the base powder purity and quality, but most importantly by increasing the temperature and/or time of the heat treatment (i.e., stress release) of the component. The eddy current loss (AC-loss) is brought about by the production of electric currents in the iron core component due to the changing flux caused by alternating current (AC) conditions. Each individual iron-based particle must be more or less perfectly electrically isolated in order to minimize the Eddy current losses.” The level of electrical resistivity that is required to minimize the AC losses is dependent on the type of application (operating frequency), the particle size distribution, and the component size.

EP 2 252 419 B1 discloses a ferromagnetic powder composition comprising soft magnetic iron-based core particles, wherein the surface of the core particles is coated with a first phosphor-based inorganic insulative layer and at least one metal-organic layer, located outside the first layer of a metal-organic compound in acetone having the following general formula:

R₁[(R₁)ₓ(R₂)_{y}(M2)]ₙOₙ₋₁R₁ (1)
wherein M2 is a central atom selected from Si, Ti, Al, or Zr;
O is oxygen;
R₁ is a hydrolysable group;
R₂ is an organic moiety and wherein at least one R₂ contains at least one amino group;
wherein n is the number of repeatable units and n=2-20; wherein x is 0 or 1;
wherein y is 1 or 2;
wherein a metallic or semi-metallic particulate compound having a Mohs hardness of less than 3.5 being adhered to at least one metal-organic layer; and wherein the powder composition further comprises a particulate lubricant; wherein the metallic or semi-metallic particulate compound is bismuth(III) oxide.

A fundamental problem of the coating process in EP 2252419 is it reliance on organic solvent for the coating process of the metal-organic layer. The present invention is aimed at solutions for overcoming this fundamental problem.

U.S. Pat. No. 10,741,316 discloses a ferromagnetic powder composition including soft magnetic iron-based core particles, wherein the surface of the core particles is coated with at least one phosphor-based inorganic insulative layer and then at least partially covered with metal-organic compound(s), wherein the total amount of metal-organic compound(s) is between 0.005 and 0.05% by weight of the powder composition, and wherein the powder composition further includes a lubricant.

In U.S. Pat. Nos. 4,601,753 and 4,601,765 to Soileau et al. the feasibility of contacting iron powders with silicates for improving the magnetic properties of the same uncoated iron powders were tested.

It is a problem in the state of the art that solvents are utilized to prepare coatings for metal powders. It is desired to provide a ferromagnetic powder composition comprising soft magnetic iron-based core particles, which are manufactured in a way which is more environment friendly compared to the methods used today, and at the same time does not give worse quality of the powder compared to the methods used today.

### Definitions

Before the invention is disclosed and described in detail, it is to be understood that this invention is not limited to particular configurations, process steps and materials disclosed herein as such configurations, process steps and materials may vary somewhat.

It must be noted that, as used in this specification and the appended claims, the words “a”, “an” and “the” include plural referents unless the context clearly dictates otherwise.

“Powder” as used herein denotes a plurality of core particles that constitute the powder. The core particles are made of metal or a metal alloy, typically with oxides on the surface.

“Powder composition” as used herein denotes the soft magnetic iron-based core particles and additional compounds including any coatings, lubricants and binders applied to the said core particles.

The core particles may have different sizes. Particles in a powder have a size distribution. Within this application, the particle size distribution is measured by weighing the different sieve fractions, according to ISO 4497:2020. The average particle size is then calculated from the particle size distribution according to ISO 9276-2:2014.

For the bismuth(III) oxide particles, the particle size is defined by providing D₅₀. D₅₀ is the median diameter or the medium value of the particle size distribution, it is the value of the particle diameter at 50% in the cumulative distribution. It is measured according to SS-ISO 13320-1.

Soft magnetic iron-based core particles (11) are known in the art and are used in many applications. For characterization of such soft magnetic iron-based core particles (11) and in the context of this application, we have measured the following parameters as a measure of functionality of the coating:
Electrical resistivity—the measure of how the material resist electric current (μΩm).
Maximal permeability—is a measure of magnetization that a material obtains in response to an applied magnetic field (unitless).
Square toroid density—The density of the magnetic square toroid used for evaluation of the magnetic properties (g/cm³)
Magnetic flux—The induction obtained for a given applied magnetic field (T)
Total core loss—The total core loss obtained for a given induction and frequency (W/kg)
TRS—Transverse rupture strength according to SS-EN ISO 3325:2000, on bars with dimensions of 30×12×6 mm (MPa).

All the parameters were compared to commercially available soft magnetic powder composition, and were in general found to be at least on par with results obtained using soft magnetic powder compositions found in the prior art.

### SUMMARY OF THE INVENTION

In a first aspect and embodiments thereof, there is herein disclosed a ferromagnetic powder composition comprising soft magnetic iron-based core particles (11),
wherein at least 80 wt % of the core particles (11) has a particle size distribution within the range from 20 to 1000 μm, measured according to ISO 4497:2020,
wherein the surface of the core particles (11) is at least partially coated with a first coating (12a) comprising an aqueous silicate of the general formula (M₂O)_{α}(SiO₂)_{β},
   wherein α is moles of M₂O, β is moles of SiO₂, and the β/α molar ratio is in the interval from 0.5 to 4.1,
   wherein M is selected from Li, Na, and K,
wherein the first coating (12a) is in direct contact with a surface of the core particles (11) of the ferromagnetic powder,
wherein the silicate is present in the amount of from 0.02 to 1.0 wt % calculated based on the total weight of the ferromagnetic powder composition, and
wherein the first coating (12a) is acid treated with an aqueous acid after forming the first coating (12a) on the iron-based core particles (11).

In a preferred embodiment of the ferromagnetic powder composition, M is potassium (K).

In a further preferred embodiment of the ferromagnetic powder composition, the aqueous acid is either aqueous phosphoric acid or aqueous nitric acid, most preferably aqueous phosphoric acid.

In an embodiment, the ferromagnetic powder composition comprises on the first coating (12a) bismuth(III) oxide particles (14) are deposited, the bismuth(III) oxide particles (14) having a D₅₀ measured according to SS-ISO 13320-1 in the interval from 0.1 to 10 μm.

In an embodiment of the ferromagnetic powder composition the core particles (11) further comprise a second coating (12b), the first coating (12a) on a core particle (11) located between the core particle (11) and the second coating (12b), the second coating (12b) formed from at least one insulative water-based organic molecule suitable for depositing at least as a monolayer on the first coating (12a).

In an embodiment of the ferromagnetic powder composition, the at least one insulative water-based organic molecule suitable for depositing at least as a monolayer on the first coating (12a) comprises:
at least one metal-organic compound (13) having the following general formula: (1) R₁[(R₁)ₓ(R₂)_{y}(M2)]ₙOₙ₋₁R₁
wherein M2 is selected from the group consisting of Si, Ti, Al, and Zr;
O is oxygen;
R₁ is a hydrolysable group;
R₂ is an organic moiety, and wherein at least one R₂ contains at least one amino group;
wherein n is the number of repeating units being an integer between 1 and 20;
wherein x is 0 or 1; and
wherein y is 1 or 2.

In an embodiment of the ferromagnetic powder composition, M2 is silicon (Si).

In an embodiment of the ferromagnetic powder composition, at least 80 wt % of the core particles is in the range from 20 to 75 μm, as measured according to ISO 4497:2020.

In an embodiment of the ferromagnetic powder composition, at least 80 wt % of the core particles is in the range from 45 to 150 μm, as measured according to ISO 4497:2020.

In an embodiment of the ferromagnetic powder composition, at least 80 wt % of the core particles is in the range from 75 to 380 μm, as measured according to ISO 4497:2020.

In a second aspect and embodiments thereof, there is herein disclosed a method for coating soft magnetic iron-based core particles (11) with a water-silicate solution, the method comprising the sequential steps of:
a. providing soft magnetic iron-based core particles (11),
b. contacting the soft magnetic iron-based core particles (11) with a first aqueous mixture comprising a silicate of the general formula (M₂O)_{α}(SiO₂)_{β}, wherein
   M is selected from Li, Na, and K,
   α is moles of M₂O, β is moles of SiO₂, and wherein the β/α molar ratio is in the interval from 0.5 to 4.1,
thereby obtaining a first coating (12a) at least partially covering the core particles (11) which is in direct contact with a surface of the core particles (11),
c. removing at least a part of the water;
d. reacting the silicate coated soft magnetic iron-based core particles (11) with an aqueous acid;
wherein
the silicate is present from 0.02 to 1.0 wt % calculated based on a total weight of the at least partially coated soft magnetic iron-based core particles.

In a particularly preferred embodiment of the method for coating soft magnetic iron-based core particles (11) with a water-silicate solution, M is potassium (K).

In a third aspect and embodiments thereof, there is herein disclosed a method for obtaining a ferromagnetic powder composition comprising coating powder comprising at least 80 wt % of soft magnetic iron-based core particles (11) having a particle size distribution within the range from 20 to 1000 μm, measured according to ISO 4497:2020 using a method according to herein detailed aspects and embodiment, prior to a subsequent process step of drying and isolating the ferromagnetic powder composition.

In an embodiment of the method for obtaining a ferromagnetic powder composition, the method further comprises prior to a subsequent process step of drying and isolating the ferromagnetic powder composition, the additional sequential steps of:
e. optionally, contacting the at least partially coated soft magnetic iron-based core particles from step c) with bismuth(III) oxide particles (14), wherein D₅₀ for the bismuth(III) oxide particles (14) as measured according to SS-ISO 13320-1 is in the interval from 0.1 to 10 μm,
f. optionally, removing at least a part of the water, and
g. contacting particles with a metal-organic compound (13) having the general formula:

R₁[(R₁)ₓ(R₂)_{y}(M2)]ₙOₙ₋₁R₁ (1)
wherein M2 is selected from the group consisting of Si, Ti, Al, and Zr;
O is oxygen;
R₁ is a hydrolysable group;
R₂ is an organic moiety and wherein at least one R₂ contains at least one amino group;
wherein n is the number of repeating units being an integer between 1 and 20;
   wherein x is 0 or 1;
   wherein y is 1 or 2.

In an embodiment of the method for obtaining a ferromagnetic powder composition, M2 is silicon (Si).

In a fourth aspects and embodiments thereof, there is herein detailed a method for manufacturing an object from a ferromagnetic powder composition according to the present disclosure, the method comprising:
h. taking the ferromagnetic powder composition from step f., and mixing the ferromagnetic powder composition with at least one lubricant,
i. optionally, pre-heating the die to a temperature below the melting temperature of the added particulate lubricant,
j. compacting the composition in a die at a compaction pressure in the range from 300 to 2000 MPa, preferably from 400 to 1200 MPa,
k. ejecting the obtained green body, and
l. heat-treating the green body in a non-reducing atmosphere, preferably comprising from 0 to 2.2 wt %, more preferably from 0.5 to 2 wt % O₂ at a temperature in the range from 300 to 800° C., preferably from 400 to 750° C., more preferably from 600 to 700° C.

### BRIEF DESCRIPTION OF THE DRAWINGS

FIG. 1: Schematic of a partially coated particle of the invention.

FIG. 2: Acid concentration influence on magnetic properties.

FIG. 3: Acid concentration influence on suspension turbidity.

FIG. 4: Acid concentration influence on suspension turbidity, comparison of phosphoric acid to nitric acid.

FIG. 5: SEM and EDS images of a potassium silicate coated iron-based powder, 100 μm scalebar.

FIG. 6: SEM and EDS images of a potassium silicate coated iron-based powder, 5 μm scalebar.

FIG. 7: SEM and EDS images of a potassium silicate coated iron-based powder: A: 250 μm scalebar, B: 100 μm scalebar.

FIG. 8: SEM and EDS images of a potassium silicate coated iron-based powder treated with H₃PO₄ at different concentrations, 25 μm scalebar.

FIG. 9: SEM and EDS images of a potassium silicate coated iron-based powder treated with H₃PO₄ with subsequently added B₂O₃ particles.

FIG. 10: SEM and EDS images of a potassium silicate coated iron-based powder treated with H₃PO₄ with subsequently added B₂O₃ particles and a top coating of Dynasylan®

It is to be understood, that the embodiments shown in the figures are for illustration of the present invention and cannot be construed as being limiting on the present invention. Unless otherwise indicated, the drawings are intended to be read (e.g., cross-hatching, arrangement of parts, proportion, degree, etc.) together with the specification, and are to be considered a portion of the entire written description of this disclosure.

### DETAILED DESCRIPTION

In the present disclosure, all embodiments and aspects of presently detailed rely on the below disclosed a ferromagnetic powder composition comprising soft magnetic iron-based core particles (11), wherein the surface of the core particles (11) is at least partially coated with a first coating (12a) comprising an aqueous silicate of the general formula (M₂O)_{α}(SiO₂)_{β},
wherein
   α is moles of M₂O,
   β is moles of SiO₂,
   and the β/α molar ratio is in the interval from 0.5 to 4.1,
wherein M is selected from Li, Na, and K,
wherein the first coating (12a) is in direct contact with a surface of the core particles (11) of the ferromagnetic powder,
wherein the silicate is present in the amount of from 0.02 to 1.0 wt % calculated based on the total weight of the ferromagnetic powder composition.

In order to obtain suitable ferromagnetic powder compositions for the uses intended herein, it is in general desirable that at least 80 wt % of the core particles (11) has a particle size distribution within the range from 20 to 1000 μm, measured according to ISO 4497:2020, however as will be easily understood by a skilled person, the present particles are prepared in aqueous solution and accordingly, any particle size and any particle distribution can be the subject of coating using the present methods in accordance with the below examples, when appropriate adjustment for volume and concentration has been undertaken in accordance with the skilled person's common general knowledge.

In a first aspect and embodiments thereof, there is herein disclosed a ferromagnetic powder composition comprising soft magnetic iron-based core particles (11),
wherein at least 80 wt % of the core particles (11) has a particle size distribution within the range from 20 to 1000 μm, measured according to ISO 4497:2020,
wherein the surface of the core particles (11) is at least partially coated with a first coating (12a) comprising an aqueous silicate of the general formula (M₂O)_{α}(SiO₂)_{β},
   wherein α is moles of M₂O, β is moles of SiO₂, and the β/α molar ratio is in the interval from 0.5 to 4.1,
   wherein M is selected from Li, Na, and K,
wherein the first coating (12a) is in direct contact with a surface of the core particles (11) of the ferromagnetic powder,
wherein the silicate is present in the amount of from 0.02 to 1.0 wt % calculated based on the total weight of the ferromagnetic powder composition, and
wherein the first coating (12a) is acid treated with an aqueous acid after forming the first coating (12a) on the iron-based core particles (11).

In a preferred embodiment of the ferromagnetic powder composition, M is potassium (K).

As discussed in the herein shown examples, ferromagnetic powders according to the present disclosure have numerous advantageous properties, when compared to ferromagnetic powders as known in the art. As shown in the examples detailed herein, through the acid treatment with an aqueous acid the silicates of the first coating (12a) undergo chemical change, thereby becoming chemically different from the silicate coatings elsewhere detailed by Soileau et al. in U.S. Pat. Nos. 4,601,753 and 4,601,765.

In a further preferred embodiment of the ferromagnetic powder composition, the aqueous acid is either aqueous phosphoric acid or aqueous nitric acid, most preferably aqueous phosphoric acid.

Based on the herein presented experiments it was possible to conclude that the aforementioned chemical change in the presence of aqueous acid involves at least partial reaction of the deposited silicates to form silica as the first coating. Further, it was possible to conclude that under optimal reaction conditions, a full conversion of silicate to silica takes place under influence of the aqueous acid.

Based on the herein presented experiments, it was possible to define an internal standard comprising a test for when silicates of the first coating (12a) has been treated with an aqueous acid, such as with preferably phosphoric acid or nitric acid, and most preferably with phosphoric acid, namely that the silicate covered surface shall present a significant increase in a detected level of at least one element characteristic of the aqueous acid used, when the silicate covered surface is measured prior and after aqueous acid treatment, the detection being by Energy Dispersive Spectroscopy (EDS), wherein measurements are made at a distance of 10 mm (working distance) using an acceleration voltage of 20 kV, a penetration depth of 1.5 μm and a detection area diameter of 1 μm, and wherein a detection result for a detected level of a characteristic element is an average of at least 4 independent detections.

Since the coatings of Soileau et al. do not rely on further chemical modification, detection of an increased level of at least one element characteristic of the aqueous acid used is a sensitive measure of distinguishing the present coatings from the coatings of Soileau et al.

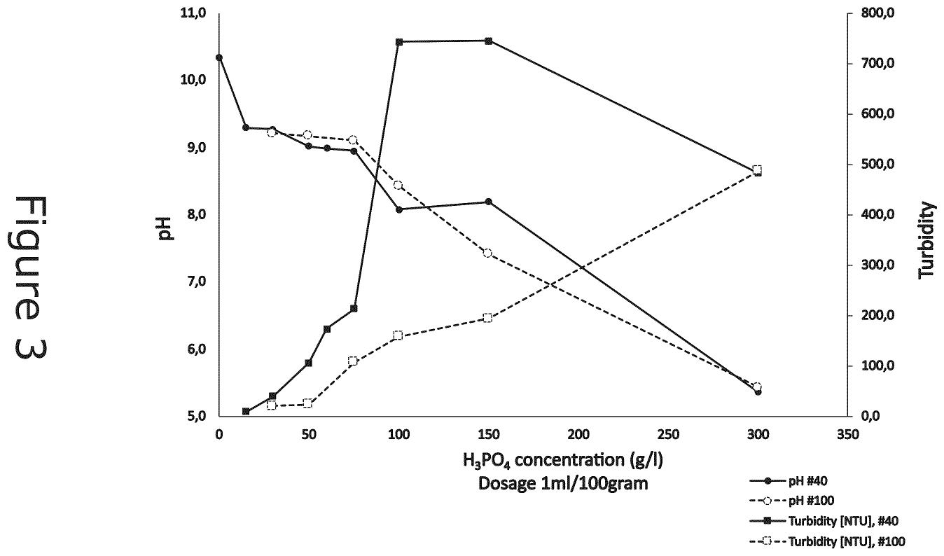

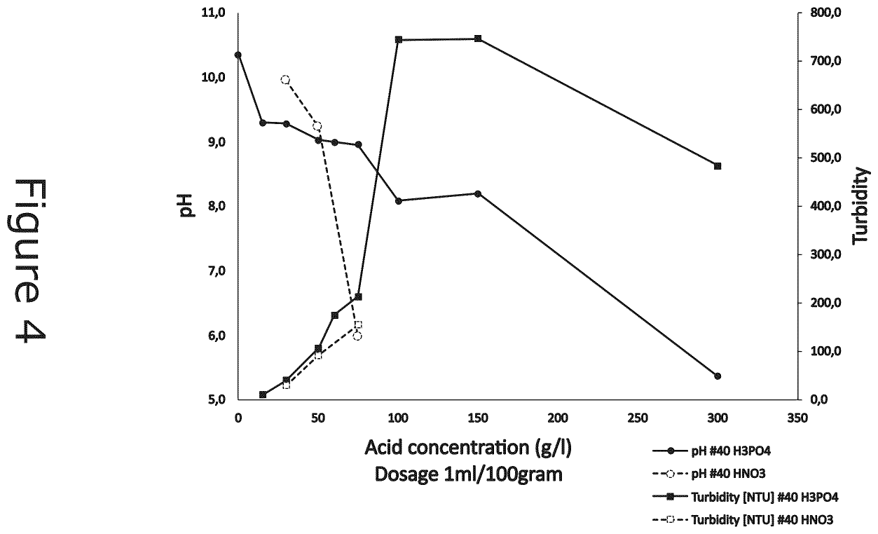

From the experiments it was observed that the acid treatment and the associated decrease in pH results in a precipitation of nano silica that facilitates the distribution of silicate to full coverage, as evidenced by the turbidity measurements (c.f. Example 12 and FIGS. 3 and 4). Accordingly, the acid treated first coating is a covering silicate coating.

It was observed that the acid treatment causes an enrichment of cations at the silicate surface (in the experiments potassium ions (K⁺) that will seek up unreacted silicate during powder processing (in the experiments stirring) and form nanosized patches. These patches have a low ratio of (SiO₂/K₂O) relative to the background coating between the patches. The patches ultimately, as the acid concentration is increased, become smaller and well distributed, contributing to the beneficial effects observed for the tribology (internal lubrication and protection from cold welding during compaction), eventually completing a full transition from silicate to silica.

Accordingly, in an embodiment, the first coating (12a) is at least a partial silica coating. In an embodiment thereof, the first coating (12a) is a fully formed silica coating.

As further observed in the experiments with phosphoric acid, too much acid eventually, after full transformation of the silicate to silica, further reacts with potassium thereby forming the observed K₃PO₄ nanocrystallites.

Thereby it is possible to define an internal test for the reaction of silicate to silica by comparing an EDS-measured content, as defined above, of an alkali metal ion (in the experiments potassium (K)) in patches after coating and before acid treatment with the content of alkali metal ion after acid treatment, wherein (c.f. Example 14) a decrease of alkali metal ion content is conclusive for the reaction from silicate to silica, and absence of further alkali metal ion content reduction after a first reduction is conclusive for the complete reaction of silicate present on the coated core particles into silica.

The measured reductions on the patches (c.f. Table 14) were respectively by factors of 14.4/4.2≈3.4 (8.5 g/l H₃PO₄) and 14.4/0.47≈30.6 (75 g/l H₃PO₄) for the partially reacted and the fully reacted surface.

In one embodiment, a core particle (11) comprises a partial silica first coating (12a) on a core particle (11) after aqueous acid treatment if an EDS-measured reduction in alkali metal content is reduced by at least a factor of 2 compared to a core particle (11) comprising a silicate first coating (12a), which has not been treated with an aqueous acid. As the fraction of a partial silica first coating (12a) increases as the EDS-measured reduction in alkali metal content is reduced, it is preferably that the EDS-measured reduction in alkali metal content is reduced by at least a factor of 3 or a factor of 4, prior to further coating with an insulative second coating (12b).

Accordingly, in embodiment, the EDS-measured alkali metal ion content is reduced by treatment of the first coating (12a) with an aqueous acid by

In an embodiment, the ferromagnetic powder composition comprises on the first coating (12a) bismuth(III) oxide particles (14) are deposited, the bismuth(III) oxide particles (14) having a D₅₀ measured according to SS-ISO 13320-1 in the interval from 0.1 to 10 μm.

In an embodiment of the ferromagnetic powder composition the core particles (11) further comprise a second coating (12b), the first coating (12a) on a core particle (11) located between the core particle (11) and the second coating (12b), the second coating (12b) formed from at least one insulative water-based organic molecule suitable for depositing at least as a monolayer on the first coating (12a).

In an embodiment of the ferromagnetic powder composition, the at least one insulative water-based organic molecule suitable for depositing at least as a monolayer on the first coating (12a) comprises:
at least one metal-organic compound (13) having the following general formula: (1)

R₁[(R₁)ₓ(R₂)_{y}(M2)]ₙOₙ₋₁R₁
wherein M2 is selected from the group consisting of Si, Ti, Al, and Zr;
O is oxygen;
R₁ is a hydrolysable group;
R₂ is an organic moiety, and wherein at least one R₂ contains at least one amino group;
wherein n is the number of repeating units being an integer between 1 and 20;
wherein x is 0 or 1; and
wherein y is 1 or 2.

In an embodiment of the ferromagnetic powder composition, M2 is silicon (Si).

In an embodiment of the ferromagnetic powder composition, at least 80 wt % of the core particles is in the range from 20 to 75 μm, as measured according to ISO 4497:2020.

In an embodiment of the ferromagnetic powder composition, at least 80 wt % of the core particles is in the range from 45 to 150 μm, as measured according to ISO 4497:2020.

In an embodiment of the ferromagnetic powder composition, at least 80 wt % of the core particles is in the range from 75 to 380 am, as measured according to ISO 4497:2020.

In an embodiment of the ferromagnetic powder composition, the silicate is present in the ferromagnetic powder composition in the amount from 0.05 to 1.0 wt %, preferably wherein the silicate is present in an amount of from 0.10 to 0.5 wt %, calculated based on the total weight of the ferromagnetic powder composition.

In an embodiment of the ferromagnetic powder composition, potassium silicate is present in an amount of from 0.1 to 0.6 wt %, calculated based on the total weight of the ferromagnetic powder composition.

In an embodiment of the ferromagnetic powder composition, the β/α molar ratio of the silicate is in the interval from 2.5 to 4.1, preferably from 2.9 to 3.5, more preferably from 3.1 to 3.4.

In an embodiment of the ferromagnetic powder composition, D₅₀ for the bismuth(III) oxide particles (14) measured according to SS-ISO 13320-1 is in the interval from 0.5 to 2 μm.

In an embodiment of the ferromagnetic powder composition, the bismuth(III) oxide particles (14) are present in an amount from 0.05 to 0.30 wt % calculated based on the total weight of the ferromagnetic powder composition.

In an embodiment of the ferromagnetic powder composition, the bismuth(III) oxide particles (14) are present in an amount of from 0.10 to 0.30 wt % calculated based on the total weight of the ferromagnetic powder composition.

In an embodiment of the ferromagnetic powder composition, the bismuth(III) oxide particles are present in an amount of from 0.10 to 0.25 wt %, and the metal-organic compound is present in an amount of from 0.10 to 0.25 wt % calculated based on the total weight of the ferromagnetic powder composition.

In an embodiment of the ferromagnetic powder composition, the metal-organic compound (13) is present in an amount of from 0.15 to 0.30 wt %, preferably in the range from 0.10 to 0.25 wt %, calculated based on the total weight of the ferromagnetic powder composition.

In an embodiment of the ferromagnetic powder composition, potassium silicate is present in an amount of from 0.10 to 0.30 wt %, wherein the bismuth(III) oxide particles (14) are present in an amount of from 0.10 to 0.20 wt %, and wherein the metal-organic compound (13) is present in an amount of from 0.10 to 0.20 wt %, calculated based on the total weight of the ferromagnetic powder composition.

In an embodiment of the ferromagnetic powder composition, the metal-organic compound is selected from the group consisting of alkoxy-terminated amino-silsesquioxanes, amino-siloxanes, oligomeric 3-aminopropyl-alkoxy-silane, 3-aminopropyl-propyl-alkoxy-silane.

In an embodiment of the ferromagnetic powder composition, the metal-organic compound is selected from the group consisting of N-aminoethyl-3-aminopropyl-alkoxy-silane, and N-aminoethyl-3-aminopropyl-methyl-alkoxy-silane.

In one particularly preferred aspect of the disclosure there is herein disclosed a ferromagnetic powder composition comprising a soft magnetic iron based core particles (11), wherein at least 80 wt % of all of the core particles (11) is in the range 20-1000 μm, measured according to ISO 4497:2020, wherein the surface of the core particles (11) is at least partially coated with a first coating (12a) comprising a silicate of the general formula (K₂O)_{α}(SiO₂)_{β}, wherein α is moles of K₂O, β is moles of SiO₂, and the β/α molar ratio is in the interval from 0.5 to 4.1, wherein the first coating (12a) is in direct contact with a surface of the core particles (11) of the ferromagnetic powder, and wherein the silicate is present in the amount of 0.02 to 1.0 wt % calculated based on the total weight of the ferromagnetic powder composition.

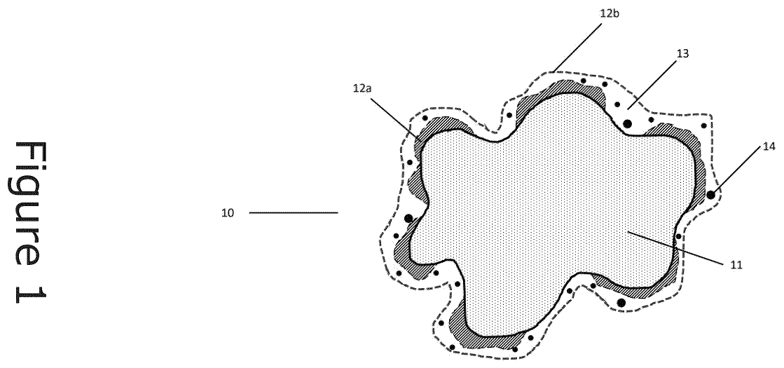

FIG. 1 shows a schematic cross section of a partially coated core particle (10). The dimensions of the coating and its components are greatly exaggerated relative to the core particle for illustration purpose. It is intended to show the principle of the core particle (10) and the different layers. The labels read exemplarily as soft-magnetic iron-based core (11); a first coating (12a); a second coating (12b); a metal-organic compound as defined in the description (13); bismuth(III) oxide particles (14). As detailed in the experiments, depending on the progress of the silicate-acid reaction, the silicate layer may form as a partial (as shown in FIG. 1) or a fully covering acid-reacted silicate-layer (not shown). As shown in the experiments, the fully covered acid-reacted silicate-layer provides the largest improvement to the magnetic properties of the present particles and powders and is hence preferred.

The size of the particles may vary significantly but it was found in the experiments that the present coatings are suitable for any particle sizes, both fine particles and coarse particles.

A suitable size range for the core particles in the powder composition determined by final use is for the core particles to have an average size in the range 20-1000 μm. The size of the core particles can suitably be, and has herein been, measured according to ISO 4497:2020 wherein the average size is suitably calculated from a particle size distribution as measured according to ISO 9276-2:2014.

Once the iron-based core particles are directly contacted with the first coating (12a) comprising silicate, the iron-based core (11) is at least partially coated, with some uncoated areas consequently present on a surface of the iron-based core (11).

This means that there may be spots on at least some of the core particles which are not covered by the first coating. Some of the core particles are entirely coated by the first coating.

However, as shown in the present experiments, when the acid-silicate reaction is allowed to proceed to termination, complete silicate coatings are predominantly observed, having optimal magnetic properties.

During production of the component from the ferromagnetic composition according to the invention the entire iron-based core will be covered with the silicate layer according to the invention.

The iron-based core (11) treated with water-based silicate solution enables for subsequent application of the insulative water-based coating thereby providing a ferromagnetic powder composition essentially free from organic solvents such as acetone.

The preferred silicate according to the invention is potassium silicate or alternatively named K-silicate, K-waterglass, potassium waterglass or simply herein silicate. It has been demonstrated by the inventors that the water-based mixture comprising silicate may be applied directly onto the iron-based core. This is a first coating (12a) in the shown experiments according to the invention.

The technical effect is demonstrated in the examples, wherein potassium silicate was used.

This product can be seen as an intermediate product and further insulative water-based coatings, such as acetone free water-based coatings can be applied as subsequent layers.

The silicate has a molar ratio from 0.5 to 4.1. In one embodiment the molar ratio β/α is in the interval 2.50 to 3.75. In another embodiment the molar ratio β/α is in the interval 2.9 to 3.5. In a further embodiment the molar ratio β/α is in the interval 3.1 to 3.4.

The silicate is present in the amount 0.02 to 1.0 wt % calculated based on the total weight of the composition. This is the amount showing the best effect as can be seen in the examples.

The amount of the at least one silicate is calculated by weight of the silicate in relation to the weight of the entire ferromagnetic powder composition. When the ferromagnetic powder composition is made, it is assumed that all silicate ends up as a coating on the metal particles.

While this may be an approximation, it has turned out that when following the methods outlined in the examples the loss of material is very low so that this approximation is sufficiently good.

In another aspect we define a ferromagnetic powder composition according to the previous embodiment, wherein the surface of the core particles (11) is coated with a second coating (12b) outside of the first coating, the second coating (12b) comprising: i) bismuth(III) oxide particles (14), wherein D50 for the bismuth(III) oxide particles (14) measured according to SS-ISO 13320-1 is in the interval 0.1 to 10 μm, and ii) at least one metal-organic compound (13) having the following general formula: (1) R₁[(R₁)ₓ(R₂)_{y}(M2)]ₙOₙ₋₁R₁ wherein M2 is selected from the group consisting of Si, Ti, Al, and Zr; O is oxygen; R₁ is a hydrolysable group; R₂ is an organic moiety and wherein at least one R₂ contains at least one amino group; wherein n is the number of repeating units being an integer between 1 and 20; wherein x is 0 or 1; wherein y is 1 or 2.

In this embodiment the ferromagnetic powder composition comprises a second coating (12b). The second coating is outside of the first coating (12a). If the first coating (12a) is not covering an entire core particle, the second coating is both outside the first coating and outside the core particle (11). The second coating (12b) is in direct contact with the first coating. If the first coating (12a) is not entirely covering the core (11), then the second coating (12b) is in direct contact with both the first coating (12a) and the core particle (11). A good function and a high resistivity of the resulting material is desired and then it is preferred that at least the second coating (12b) is entirely covering at least for most of the core particles in the powder.

The second coating (12a) comprises bismuth(III) oxide particles (14). The D₅₀ for the bismuth(III) oxide particles (14) is measured according to SS-ISO 13320-1. D₅₀ for the bismuth(III) oxide particles (14) is in the interval 0.1 to 10 μm. Thus, the bismuth(III) oxide particles (14) are smaller than the core particles (11).

The second coating (12b) also comprises the metal organic compound (13). The metal-organic compound has the following general formula: (1) R₁[(R₁)ₓ(R₂)_{y}(M2)]ₙOₙ₋₁R₁.

R₁ in the metal-organic compound is in one embodiment an alkoxy-group having less than 4, preferably less than 3 carbon atoms.

R₂ is an organic moiety, which means that the R₂-group contains an organic part or portion. R₂ in one embodiment includes 1-6, preferably 1-3 carbon atoms. R₂ may further include one or more hetero atoms selected from the group consisting of N, O, S and P. The R₂ group may be linear, branched, cyclic, or aromatic. R₂ may include one or more of the following functional groups: amine, diamine, amide, imide, epoxy, hydroxyl, ethylene oxide, ureido, urethane, isocyanato, acrylate, glyceryl acrylate, benzyl-amino, vinyl-benzyl-amino. The R₂ group may alter between any of the mentioned functional R₂-groups and a hydrophobic alkyl group with repeatable units.

It was also not suitable for direct application onto the iron-based core as a water suspension. By providing a first coating (12a) the inventors have made a surface of the iron-based core (11) suitable for application of bismuth (III) oxide particles (14) and metal organic compound (13).

According to this embodiment, the second layer (12b) comprises an oligomer of the metal-organic compound.

In one embodiment the metal-organic compound having the general formula (1) R₁[(R₁)ₓ(R₂)_{y}(M2)]ₙOₙ₋₁R₁ is at least one metal-organic compound selected from the group consisting of N-aminoethyl-3-aminopropyl-alkoxy-silane, and N-aminoethyl-3-aminopropyl/methyl-alkoxy-silane. These two metal-organic compounds are secondary amines and react slightly slower compared to for instance primary amines.

In one of the embodiments of the present ferromagnetic powder compositions according to any one of preceding embodiments, wherein at least 80 wt % of the core particles is in the range from 20 to 75 μm, as measured according to ISO 4497:2020. In the context of the present disclosure, particles falling within this size range are considered finely sized or simply fine.

The size is given for fine particles suitable for high frequency applications, such as sensors, inductors, and converters. Example 6 show that the coating works for such fine particles.

In one of the embodiments the ferromagnetic powder composition according to any of the other embodiments wherein at least 80 wt % of the core particles is in the range from 45 to 150 μm, as measured according to ISO 4497:2020. In the context of the present disclosure, particles falling within this size range are considered medium sized or simply medium.

The size range for the medium sized particles is suitable for low to medium frequency applications, such as electric motors, generators, and converters. Examples 4 and 5 show that the coating works for these medium sized particles.

In another embodiment the ferromagnetic powder composition according to any other embodiments, wherein at least 80 wt % of the core particles is in the range from 75 to 380 μm, as measured according to ISO 4497:2020. In the context of the present disclosure, particles falling within this size range are considered coarsely sized or simply coarse.

The size is given for fine particles suitable for low frequency applications, such as electric motors, generators, and actuators. Examples 1 to 5 and 7 to 10 show that the coating works for these relatively coarse particles.

In some embodiments, the preferred amounts of the at least one silicate, the bismuth(III) oxide particles (14) and the metal-organic compound (13) depend on the size of the core particles (11). Thus, several embodiments are presented for different average size of the core particles (11). The intervals for different average size of the core particles are from 20 to 75 μm, from 45 to 150 μm, and from 75 to 380 am. The ranges are overlapping; however, they nevertheless give a relative guide for preferred ranges for the different ingredients, respectively as fine, medium, and coarse particles.

In another embodiment the ferromagnetic powder composition according to any one of the preceding embodiments, wherein the silicate is present ferromagnetic powder composition in an amount from 0.05 to 0.5 wt % calculated based on the total weight of the ferromagnetic powder composition.

It has been experimentally observed that these amounts of silicate are suitable for working the invention. Fine powders may require relatively higher amounts silicate compared to coarse powders, suitable amounts for differently sized powders are illustrated in Examples 1, 2, 4 and 6. An average particle size above about 75 am may require only from 0.05 to 0.2 wt % silicate for a complete coating to form, while a finer average particle size may require a higher amount such as from 0.1 to 0.5 wt % silicate, as expected based on their relative surface area ratios. Higher amounts of silicates can be used but do not result in higher coatings beyond fully coated.

In another embodiment the ferromagnetic powder composition according to any one of the preceding embodiments, wherein the β/α molar ratio of the silicate is in the interval from 2.5 to 4.1, preferably from 2.9 to 3.5, more preferably from 3.1 to 3.4.

A molar ratio which is too low causes poor coating quality and gives low electrical resistivity. Conversely, a molar ratio which is too high makes the water-based silicate solution instable and lump precipitates may occur, thus causing poor coating quality and low electrical resistivity. By applying a silicate within the preferred interval, the coating quality was found to be optimal.

In another embodiment the ferromagnetic powder composition according to any one the preceding claims, wherein D₅₀ for the bismuth(III) oxide particles (14) measured according to SS-ISO 13320-1 is in the interval 0.5 to 2 μm.

This amount of bismuth(III) oxide particles is in the preferred range because too coarse particles will cause a poor distribution inside the coating composition which in turn gives poor magnetic and/or mechanical properties. Too fine particles tend to agglomerate and are consequently difficult to handle.

In another embodiment it is disclosed the ferromagnetic powder composition according to any one of the preceding embodiments, wherein the bismuth(III) oxide particles (14) are present in an amount from 0.05 to 0.3 wt % calculated based on the total weight of the ferromagnetic powder composition.

This amount of bismuth(III) oxide particles is in the preferred range because too low amount gives unsatisfactory magnetic and mechanical properties and too high amount gives mainly poor density and thus poor magnetic properties. Powders having a fine particle size distribution may require a higher amount (D₅₀<70 μm; 0.15-0.3 wt %) as compared to the coarse powders (D₅₀>70 μm; 0.05-0.2 wt %).

In another embodiment it is disclosed the ferromagnetic powder composition according to any one of the preceding embodiments, wherein potassium silicate is present in an amount of from 0.1 to 0.6 wt %, calculated based on the total weight of the ferromagnetic powder composition.

This amount of silicate is in the preferred range because too low an amount cannot sufficiently cover the particles' surfaces and cause rust and poor magnetic properties. Too high amounts will cause poor density and thus poor magnetic properties (c.f. Example 10).

In another embodiment it is disclosed the ferromagnetic powder composition according to any one of the preceding embodiments, wherein the bismuth(III) oxide particles (14) are present in an amount of from 0.10 to 0.30 wt % calculated based on the total weight of the ferromagnetic powder composition.

In another embodiment it is disclosed the ferromagnetic powder composition according to any one of the proceeding embodiments wherein the bismuth(III) oxide particles are present in an amount of from 0.10 to 0.25 wt %, and the metal-organic compound is present in an amount of from 0.10 to 0.25 wt % calculated based on the total weight of the ferromagnetic powder composition.

This embodiment is a particularly preferable embodiment of the present disclosure, as the interval amounts cover the most frequent amounts used for both fine and coarse iron-based core powders.

In another embodiment it is disclosed the ferromagnetic powder composition according to any one of the preceding embodiments, wherein the metal-organic compound (13) is present in an amount of from 0.15 to 0.30 wt %, preferably in the range from 0.10 to 0.25 wt % calculated based on the total weight of the ferromagnetic powder composition.

This embodiment is a particularly preferable embodiment of the present disclosure as the interval amounts cover the most frequent amounts used for both fine and coarse iron-based core powders.

In another embodiment it is disclosed the ferromagnetic powder composition according to any one of the preceding embodiments, wherein potassium silicate is present in an amount of from 0.1 to 0.3 wt %, wherein the bismuth(III) oxide particles (14) are present in an amount of from 0.10 to 0.20 wt % and wherein the metal-organic compound (13) is present in an amount of from 0.10 to 0.20 wt %, calculated based on the total weight of the ferromagnetic powder composition.

In another embodiment it is disclosed the ferromagnetic powder composition according to any one of the preceding embodiments, wherein the metal-organic compound is selected from the group consisting of alkoxy-terminated amino-silsesquioxanes, amino-siloxanes, oligomeric 3-aminopropyl-alkoxy-silane, 3-aminopropyl/propyl-alkoxy-silane.

The metal-organic compound is in one embodiment selected from derivates, intermediates or oligomers of silanes, siloxanes and silsesquioxanes or the corresponding titanates, aluminates, or zirconates.

In another embodiment it is disclosed the ferromagnetic powder composition according to any one of the preceding embodiments, wherein the metal-organic compound is selected from the group consisting of N-aminoethyl-3-aminopropyl-alkoxy-silane, and N-aminoethyl-3-aminopropyl/methyl-alkoxy-silane.

In one embodiment the average size of the core particles is in the range from 20 to 75 μm, as measured according to ISO 4497:2020, wherein the at least one silicate comprises potassium silicate, wherein at least one silicate is present in an amount in the range from 0.10 to 1.0 wt %, wherein the bismuth(III) oxide particles (14) are present in an amount from 0.10 to 0.30 wt %, and wherein the metal-organic compound is present in an amount from 0.15 to 0.30 wt %. Example 6 illustrates typical amounts of additives for a core powder comprising relatively fine sized particles.

In one embodiment the average size of the core particles is in the range from 45 to 150 μm, as measured according to ISO 4497:2020, wherein potassium silicate is present in an amount from 0.1 to 0.6 wt %, wherein the bismuth(III) oxide particles (14) are present in an amount from 0.10 to 0.25 wt % and wherein the metal-organic compound (13) is present in an amount in the range 0.10 to 0.25 wt %. Examples 4 and 5 illustrate typical amounts for a core powder comprising medium sized particles.

In one embodiment the average size of the core particles (11) is in the range from 75 to 380 μm, as measured according to ISO 4497:2020, wherein the potassium silicate is present in an amount in the range from 0.05 to 0.3 wt %, wherein the bismuth(III) oxide particles (14) are present in an amount from 0.10 to 0.20 wt %, and wherein the metal-organic compound (13) is present in an amount from 0.10 to 0.20 wt %.

The total amount of the metal-organic compound (13) is in one embodiment from 0.05 to 0.6%, preferably from 0.05 to 0.5%, more preferably from 0.1 to 0.4%, and most preferably from 0.10 to 0.20% by weight of the ferromagnetic powder composition. In one embodiment, the metal-organic compound (13) is present in an amount in the range from 0.15 to 0.30 wt %, preferably in the range from 0.10 to 0.25 wt %. This is the amount of as-received liquid metal-organic compound in relation to the total weight of the powder composition.

In one embodiment, the bismuth(III) oxide particles are present in an amount from 0.10 to 0.25 wt % calculated based on the ferromagnetic powder composition, and wherein the metal-organic compound is present in an amount from 0.10 to 0.25 wt %. This is the amount of liquid as-received metal-organic compound in relation to the total weight of the powder composition.

In one embodiment, the potassium silicate is present in an amount in the range from 0.10 to 0.30 wt %, wherein the bismuth(III) oxide particles (14) are present in an amount from 0.10 to 0.20 wt %, and wherein the metal-organic compound (13) is present in an amount from 0.05 to 0.20 wt %.

The same embodiments disclosed and discussed above are equally applicable to the below mentioned methods. However, some additional aspects related to these methods will be discussed herein below.

In a second aspect and embodiments thereof, there is herein disclosed a method for coating soft magnetic iron-based core particles (11) with a water-silicate solution, the method comprising the sequential steps of:
a. providing soft magnetic iron-based core particles (11),
b. contacting the soft magnetic iron-based core particles (11) with a first aqueous mixture comprising a silicate of the general formula (M₂O)_{α}(SiO₂)_{β}, wherein
   M is selected from Li, Na, and K,
   α is moles of M₂O, β is moles of SiO₂, and wherein the β/α molar ratio is in the interval from 0.5 to 4.1,
thereby obtaining a first coating (12a) at least partially covering the core particles (11) which is in direct contact with a surface of the core particles (11),
c. removing at least a part of the water;
d. reacting the silicate coated soft magnetic iron-based core particles (11) with an aqueous acid;
wherein
the silicate is present from 0.02 to 1.0 wt % calculated based on a total weight of the at least partially coated soft magnetic iron-based core particles.

In a particularly preferred embodiment of the method for coating soft magnetic iron-based core particles (11) with a water-silicate solution, M is potassium (K).

In an embodiment of the method for coating soft magnetic iron-based core particles (11) with a water-silicate solution, the aqueous acid is phosphoric acid or nitric acid, preferably phosphoric acid.

In an embodiment of the method for coating soft magnetic iron-based core particles (11) with a water-silicate solution, steps b) and c) are repeated at least once.

In an embodiment of the method for coating soft magnetic iron-based core particles (11) with a water-silicate solution, from 0.05 to 0.5 wt % of the silicate calculated based on the total weight of the ferromagnetic powder composition is added in step b).

In an embodiment of the method for coating soft magnetic iron-based core particles (11) with a water-silicate solution, the β/α molar ratio of the silicate is in the interval from 2.5 to 4.1, preferably from 2.9 to 3.5, more preferably from 3.1 to 3.4.

In embodiments thereof, there is herein disclosed, a method for coating soft magnetic iron-based core particles (11) with a water-silicate solution, the method comprising the sequential steps of:
a. providing soft magnetic iron-based core particles (11),
b. contacting the soft magnetic iron-based core particles (11) with a first aqueous mixture comprising a silicate of the general formula (K₂O)_{α}(SiO₂)_{β}, α is moles of K₂O, β is moles of SiO₂, wherein the β/α molar ratio is in the interval from 0.5 to 4.1, thereby obtaining a first coating (12a) at least partially covering the core particles (11) and being in direct contact with a surface of the core particles (11),
c. removing at least a part of the water, thereby obtaining at least partially coated, soft magnetic iron-based core particles (11) suitable for subsequent coating with an insulative water-based coating;
wherein the silicate is present from 0.02 to 1.0 wt % calculated based on a total weight of the at least partially coated soft-magnetic iron-based core particles.

This method provides for obtaining an intermediate product, an iron-based core particle coated with a first coating (12a). This coating provides a surface suitable for application of a subsequent coating which is water based and not acetone based, which is used in the prior art.

The method can be continued with additional steps to apply at least a further coating from an aqueous liquid as for instance in the next embodiment.

The core particles are provided uncoated for the first coating. No coating should be applied to the core particles before the first coating.

The core particles are contacted with a first aqueous mixture comprising the silicate. The silicate is preferably diluted in water to form an aqueous silicate solution having a suitable solid content. The silicate typically forms poly-ions in the aqueous solution and the silicate is distributed and adsorbed to the surface of the core particles. In most cases, essentially all silicate molecules are adsorbed to the surface of the core particles.

After the first coating, water is removed, at least partially. It is conceived that water typically remains in the powder composition at least as crystal water. In one embodiment water is removed by stirring and heating in the mixer where the silicate was added. In one embodiment, the removal of water is made by drying in a drying cabinet. Also, combinations of different methods of removing water are encompassed. Other methods of removing water are also possible to use.

The water in the composition is not necessarily removed entirely. A fraction of water may still be left. The water left in the powder composition can both be free water and water bound to various ions, forming hydrates and salts. In one embodiment all water is removed.

In a further aspect and embodiments thereof, there is herein disclosed a method for obtaining a ferromagnetic powder composition comprising coating powder comprising at least 80 wt % of soft magnetic iron-based core particles (11) having a particle size distribution within the range from 20 to 1000 μm, measured according to ISO 4497:2020 using a method according to herein detailed aspects and embodiment, prior to a subsequent process step of drying and isolating the ferromagnetic powder composition.

In an embodiment of the method for obtaining a ferromagnetic powder composition, the method further comprises prior to a subsequent process step of drying and isolating the ferromagnetic powder composition, the additional sequential steps of:
e. optionally, contacting the at least partially coated soft magnetic iron-based core particles from step c) with bismuth(III) oxide particles (14), wherein D₅₀ for the bismuth(III) oxide particles (14) as measured according to SS-ISO 13320-1 is in the interval from 0.1 to 10 μm,
f. optionally, removing at least a part of the water, and
g. contacting particles with a metal-organic compound (13) having the general formula:

R₁[(R₁)ₓ(R₂)_{y}(M2)]ₙOₙ₋₁R₁ (1)
wherein M2 is selected from the group consisting of Si, Ti, Al, and Zr;
O is oxygen;
R₁ is a hydrolysable group;
R₂ is an organic moiety and wherein at least one R₂ contains at least one amino group;
wherein n is the number of repeating units being an integer between 1 and 20;
wherein x is 0 or 1;
wherein y is 1 or 2.

In an embodiment of the method for obtaining a ferromagnetic powder composition, M2 is silicon (Si).

In an embodiment of the method for obtaining a ferromagnetic powder composition, step e) is included.

In an embodiment of the method for obtaining a ferromagnetic powder composition, step f) is included.

In an embodiment of the method for obtaining a ferromagnetic powder composition, both steps e) and f) are included

In an embodiment of the method for obtaining a ferromagnetic powder composition, at least 80 wt % of the provided core particles (11) is in the range from 20 to 75 μm, as measured according to ISO 4497:2020.

In an embodiment of the method for obtaining a ferromagnetic powder composition, at least 80 wt % of the core particles (11) is in the range from 45 to 150 μm, as measured according to ISO 4497:2020.

In an embodiment of the method for obtaining a ferromagnetic powder composition, at least 80 wt % of the core particles (11) is in the range from 75 to 380 μm, as measured according to ISO 4497:2020.

In an embodiment of the method for obtaining a ferromagnetic powder composition, D₅₀ for the bismuth(III) oxide particles (14) as measured according to SS-ISO 13320-1 is in the interval from 0.5 to 2 μm.

In an embodiment of the method for obtaining a ferromagnetic powder composition, bismuth(III) oxide particles (14) are present in an amount from 0.05 to 0.30 wt %, preferably from 0.10 to 0.30 wt %, calculated based on the total weight of the ferromagnetic powder composition.

In an embodiment of the method for obtaining a ferromagnetic powder composition, the silicate is present in an amount in the range from 0.10 to 1.0 wt %, preferably from 0.10 to 0.6 wt %, calculated based on the total weight of the ferromagnetic powder composition.

In an embodiment of the method for obtaining a ferromagnetic powder composition, the metal-organic compound (13) is present in the range from 0.15 to 0.30 wt %, preferably in the range from 0.10 to 0.25 wt %, calculated based on the total weight of the ferromagnetic powder composition.

In an embodiment of the method for obtaining a ferromagnetic powder composition, the bismuth(III) oxide particles (14) are present in an amount of from 0.10 to 0.25 wt %, and wherein the metal-organic compound (13) is present in an amount of from 0.10 to 0.25 wt % calculated based on the total weight of the ferromagnetic powder composition.

In an embodiment of the method for obtaining a ferromagnetic powder composition, the silicate is a potassium waterglass, and is present in an amount from 0.10 to 0.30 wt %, wherein the bismuth(III) oxide particles (14) are present in an amount from 0.10 to 0.20 wt %, and wherein the metal-organic compound is present in an amount from 0.05 to 0.20 wt %.

In an embodiment of the method for obtaining a ferromagnetic powder composition, the metal-organic compound is selected from the group consisting of alkoxy-terminated amino-silsesquioxanes, amino-siloxanes, oligomeric 3-aminopropyl-alkoxy-silane, 3-aminopropyl-propyl-alkoxy-silane.

In an embodiment of the method for obtaining a ferromagnetic powder composition, the metal-organic compound is selected from the group consisting of N-aminoethyl-3-aminopropyl-alkoxy-silane, and N-aminoethyl-3-aminopropyl-methyl-alkoxy-silane.

Further, there is herein disclosed in an embodiment, the method for obtaining a ferromagnetic powder composition, wherein the method comprises the additional sequential steps of:
e. contacting the at least partially coated soft-magnetic iron-based core particles from step c) with bismuth(III) oxide particles (14), wherein D₅₀ for the bismuth(III) oxide particles (14) as measured according to SS-ISO 13320-1 is in the interval 0.1 to 10 μm,
f. removing at least a part of the water,
g. contacting particles with a metal-organic compound (13) having the general formula:

R₁[(R₁)ₓ(R₂)_{y}(M2)]ₙOₙ₋₁R₁ (1)
wherein M2 is selected from the group consisting of Si, Ti, Al, and Zr; O is oxygen; R₁ is a hydrolysable group; R₂ is an organic moiety, and wherein at least one R₂ contains at least one amino group;
wherein n is the number of repeating units being an integer between 1 and 20; and
wherein x is 0 or 1 and y is 1 or 2.

Further, there is herein disclosed in an embodiment, the method for obtaining a ferromagnetic powder composition method according to any one of the preceding method embodiments, wherein the method comprises a step d) of adding at least one acid after step c), the acid is selected from the group consisting of phosphoric acid and nitric acid. The effect of treating the powder with an acid, preferably diluted in water, is illustrated in the examples.

In another embodiment of the method, wherein steps b) and c) may be repeated at least once.

In another embodiment of the method, at least 80 wt % of the provided core particles (11) is in the range from 20 to 75 μm, as measured according to ISO 4497:2020.

In another embodiment of the method, at least 80 wt % of the core particles (11) is in the range from 45 to 150 μm, as measured according to ISO 4497:2020.

In another embodiment of the method, at least 80 wt % of the core particles (11) is in the range from 75 to 380 μm, as measured according to ISO 4497:2020.

It is disclosed in the embodiment the method according to any one of the preceding embodiments, wherein from 0.05 to 0.5 wt % of the silicate calculated based on the total weight of the ferromagnetic powder composition is added in step b).

It is disclosed in the embodiment the method according to any one of the preceding embodiments, wherein the β/α molar ratio is in the interval from 2.5 to 4.1, preferably from 2.9 to 3.5, more preferably from 3.1 to 3.4.

It is disclosed in the embodiment the method according to any one of the preceding embodiments, wherein D₅₀ for the bismuth(III) oxide particles (14) as measured according to SS-ISO 13320-1 is in the interval from 0.5 to 2 μm.

It is disclosed in the embodiment the method according to any one of the preceding embodiments, wherein the bismuth(III) oxide particles (14) are present in an amount from 0.05 to 0.3 wt % calculated based on the total weight of the ferromagnetic powder composition.

It is disclosed in the embodiment the method according to any one of the preceding claims, wherein the silicate is present in an amount in the range from 0.1 to 1.0 wt % calculated based on the total weight of the ferromagnetic powder composition.

It is disclosed in the embodiment the method according to any one of the preceding embodiments, wherein the bismuth(III) oxide particles (14) are present in an amount in the range from 0.10 to 0.30 wt % calculated based on the total weight of the ferromagnetic powder composition.

It is disclosed in the embodiment the method according to any one of the preceding embodiments, wherein the silicate is potassium waterglass, in an amount in the range from 0.1 to 0.6 wt %, calculated based on the total weight of the ferromagnetic powder composition.

It is disclosed in the embodiment the method according to any one of the preceding embodiments, wherein the bismuth(III) oxide particles (14) are present in an amount of from 0.10 to 0.25 wt %, and wherein the metal-organic compound (13) is present in an amount of from 0.10 to 0.25 wt % calculated based on the total weight of the ferromagnetic powder composition.

It is disclosed in the embodiment the method according to any one of the preceding embodiments, wherein the metal-organic compound (13) is present in the range from 0.15 to 0.30 wt %, preferably in the range from 0.10 to 0.25 wt % calculated based on the total weight of the ferromagnetic powder composition.

It is disclosed in the embodiment the method according to any one of the preceding embodiments, wherein the silicate is a potassium waterglass, and is present in an amount from 0.10 to 0.30 wt %, wherein the bismuth(III) oxide particles (14) are present in an amount from 0.10 to 0.20 wt % and wherein the metal-organic compound is present in an amount from 0.05 to 0.20 wt %.

It is disclosed in the embodiment the method according to any one of the preceding embodiments, wherein the metal-organic compound is selected from the group consisting of alkoxy-terminated amino-silsesquioxanes, amino-siloxanes, oligomeric 3-aminopropyl-alkoxy-silane, 3-aminopropyl/propyl-alkoxy-silane.

It is disclosed in the embodiment the method according to any one of the previous embodiments, wherein the metal-organic compound is selected from the group consisting of N-aminoethyl-3-aminopropyl-alkoxy-silane, and N-aminoethyl-3-aminopropyl-methyl-alkoxy-silane.

In a further aspect and embodiments thereof, there is herein detailed a method for manufacturing an object from a ferromagnetic powder composition according to the present disclosure, the method comprising:
h. taking the ferromagnetic powder composition from step f., and mixing the ferromagnetic powder composition with at least one lubricant,
i. optionally, pre-heating the die to a temperature below the melting temperature of the added particulate lubricant,
j. compacting the composition in a die at a compaction pressure in the range from 300 to 2000 MPa, preferably from 400 to 1200 MPa,
k. ejecting the obtained green body, and
l. heat-treating the green body in a non-reducing atmosphere, preferably comprising from 0 to 2.2 wt %, more preferably from 0.5 to 2 wt % O₂ at a temperature in the range from 300 to 800° C., preferably from 400 to 750° C., more preferably from 600 to 700° C.

In an embodiment there is herein disclosed, the method for manufacturing an object from the ferromagnetic powder composition said method comprising additional steps: g) taking the ferromagnetic powder composition from step f) and mixing the ferromagnetic powder composition with at least one lubricant, h) compacting the composition in a die at a compaction pressure in the range 300-2000 MPa, preferably 400-1200 MPa,
m. optionally pre-heating the die to a temperature below the melting temperature of the added particulate lubricant,
n. ejecting the obtained green body, and
o. heat-treating the green body in a non-reducing atmosphere, preferably comprising 0-22 wt %, more preferably from 0.5 to 2 wt % O₂ at a temperature in the range from 300 to 800° C., preferably from 400 to 750° C., more preferably from 600 to 700° C.

After the at least partial removal of water the ferromagnetic powder composition is contacted with bismuth(III) oxide particles. In one embodiment this is made by dispersing the bismuth(III) oxide particles in water and adding the dispersion to the powder composition. In one embodiment the powder composition is mixed in a mixer upon and after the addition.

In another embodiment the bismuth(III) oxide particles (14) may be already mixed with and dispersed in the aqueous silicate solution and coated according to step b, followed by step c. The step d may thus be omitted.

Subsequently, the powder composition is contacted with the metal-organic compound having the general formula (1) R₁[(R₁)ₓ(R₂)_{y}(M)]ₙOₙ₋₁R₁. In one embodiment, the powder composition is mixed in a mixer upon, during and after the addition. Such continuous mixing has the advantage of a simpler manufacturing process. The bismuth(III) oxide particles and the metal-organic compound form the second coating.

In one embodiment the method comprises a step of adding at least one acid after step c), wherein the acid is selected from the group consisting of an organic acid, and a mineral acid. In one embodiment the acid is selected from the group consisting of phosphoric acid, and nitric acid. The selected acid is preferably diluted in water prior addition.

In one embodiment steps b) and c) are repeated at least once. By this, two or more layers of the first coating are applied. This gives a higher probability that each individual core particle will become entirely covered by the coating.

In another embodiment the molar ratio of the silicate solution is different, such as the first applied layer of step b has a higher molar ratio relatively the second applied layer. This procedure may provide a first coating with an improved particle coverage.

The powder composition is dried in step c) before step d) in one of the embodiments. This improves the application of the metal-organic compound for the second coating.

In one embodiment the method comprises the further steps including compacting of the ferromagnetic composition to an object. In one embodiment the method further comprises the additional sequential steps for manufacturing an object from the ferromagnetic powder composition: g) taking the ferromagnetic powder composition from step f) and mixing the ferromagnetic powder composition with at least one lubricant, h) compacting the composition in a die at a compaction pressure in the range from 300 to 2000 MPa, preferably from 400 to 1200 MPa, i) optionally pre-heating the die to a temperature below the melting temperature of the added particulate lubricant, j) ejecting the obtained green body, and k) heat-treating the green body in a non-reducing atmosphere, the non-reducing atmosphere preferably being nitrogen gas, preferably comprising from 0 to 2.2 wt %, more preferably from 0.5 to 2 wt % O₂ (oxygen gas) at a temperature in the range from 300 to 800° C., preferably from 400 to 750° C., more preferably from 600 to 700° C.

By this method steps an object is manufactured from the ferromagnetic powder composition.

In one embodiment, the lubricant is a particulate lubricant. The particulate lubricant enables compaction without the need of applying die wall lubrication. The particulate lubricant is in one embodiment at least one lubricant selected from the group consisting of primary and secondary fatty acid amides, trans-amides (bisamides) or fatty acid alcohols. The lubricating moiety of the particulate lubricant may be a saturated or unsaturated chain containing between 12-22 carbon atoms. The particulate lubricant may preferably be selected from stearamide, erucamide, stearylerucamide, erucyl-stearamide, behenyl alcohol, erucyl alcohol, ethylene-bisstearamide (i.e., EBS or amide wax). The particulate lubricant may be present in an amount of from 0.15 to 0.80%, preferably from 0.20 to 0.40% by weight of the composition.

In one embodiment the amount of added lubricant is less, such as from 0.05 to 1.5 wt %, but the compaction (steps m-o) is done using die wall lubrication (DWL). The benefit of this is an improved density of the compacted body for a specific compaction pressure.

Accordingly, in a fourth aspects and embodiments thereof, there is herein detailed a method for manufacturing an object from a ferromagnetic powder composition according to the present disclosure, the method comprising:
p. taking the ferromagnetic powder composition from step f., and mixing the ferromagnetic powder composition with at least one lubricant,
q. optionally, pre-heating the die to a temperature below the melting temperature of the added particulate lubricant,
r. compacting the composition in a die at a compaction pressure in the range from 300 to 2000 MPa, preferably from 400 to 1200 MPa,
s. ejecting the obtained green body, and
t. heat-treating the green body in a non-reducing atmosphere, preferably comprising from 0 to 2.2 wt %, more preferably from 0.5 to 2 wt % O₂ at a temperature in the range from 300 to 800° C., preferably from 400 to 750° C., more preferably from 600 to 700° C.

The method for the preparation of soft-magnetic composite materials according to the invention comprise: uniaxially compacting the composition according to the invention in a die at a compaction pressure of at least about 300 MPa, preferably at least 600 MPa; optionally pre-heating the die to a temperature below the melting temperature of the added particulate lubricant; ejecting the obtained green body; and optionally heat-treating the body.

The compaction may be cold die compaction, warm die compaction, or high-velocity compaction, preferably a controlled die temperature compaction (50-120° C.) with an unheated powder is used.

The heat-treatment process may be in vacuum, non-reducing, inert or in weakly oxidizing atmospheres, e.g., from 0.01 to 3 wt % oxygen. In one embodiment, a nitrogen atmosphere is used as a non-reducing atmosphere. In one embodiment with addition of from 0 to 2.2 wt % oxygen, preferably from 0.5 to 2 wt % oxygen. Optionally, the heat treatment is performed in an inert atmosphere and thereafter exposed quickly in an oxidizing atmosphere, to build a superficial crust of higher strength. The temperature may in one embodiment be up to 800° C.

It is considered that the heat treatment conditions will allow the lubricant to be evaporated as completely as possible. This is normally obtained during the first part of the heat treatment cycle, above about 300 to 500° C. At higher temperatures, the metallic or semi-metallic compound may react with the metal-organic compound and partly form a glassy network. This would further enhance the mechanical strength, as well as the electrical resistivity of the component. At maximum temperature (more preferably from 600 to 700° C.), the compact may reach complete stress release at which the coercivity and thus the hysteresis loss of the composite material is minimized.

The first coating, i.e., the coating comprising at least one silicate is utilized to prepare the powder for application of further coatings, which are applied from water-based solutions or mixtures. It has unexpectedly been found that the treatment with at least one silicate can prepare the powder for a subsequent coating in an aqueous system.

In another embodiment it is disclosed an use of at least one silicate with the general formula (K₂O)_{α}(SiO₂)_{β}, wherein α is moles of K₂O, β is moles of SiO₂, wherein the β/α molar ratio is in the interval from 0.5 to 4.1, directly on the surface of the soft-magnetic iron-based particles (14) as a first coating (12a), thereby rendering the particles suitable for coating with water based chemicals or compounds, essentially free from any organic solvents. Organic solvent often being toxic, explosive, or environmentally unfriendly.

Examples of further coatings which can be applied after the first coating include, but are not limited to, metal salts dissolved in water.

The above-described embodiments can be combined with any above-described aspect. Further, each one of all above-described embodiments can freely be combined with one or more of the above-described embodiments.

The invention is further illustrated by the following non-limiting examples, which serve the purpose of illustrating different embodiments of the invention without being limiting for the scope of the invention.

### EXAMPLES

### Example 1

The iron powder used was a 40-mesh water atomized annealed powder with an apparent density of 3.2 g/cm³, and D₅₀ in the interval 200-250 μm as measured according to ISO 9276-2:2014. This powder has at least 80 wt % of the core particles in the range 75-380 μm, as measured according to ISO 4497:2020.

The powder was first coated with a coating comprising potassium silicate (K12 from Sibelco Nordic AB) by addition of an aqueous solution of potassium silicate in an amount of 0.05, 0.10 or 0.15 wt % calculated on the weight of powder composition. The potassium silicate was a potassium silicate with β/α molar ratio of 3.37. The dry weight of potassium silicate was used to calculate the amount. The coating was made with a coating solution consisting of water and potassium silicate. The coating solution was made by taking as-received potassium silicate solution with 34.3 wt % solid content and diluting it with water to a solid content of 14 wt %.

The coating solution was applied to the iron powder in the mixer, followed by mixing for 10 minutes before the mantle was heated to 80° C. and mixing continued for 30-60 minutes, until the powder appeared dry by visual inspection. It should be noted that even if the powder appears to be dry by visual inspection water is highly likely to remain, at least for instance as water of crystallization and/or as hydrates.

Further drying was done in a heating cabinet at 120° C. for 60-120 minutes. The drying in the mixer and heating cabinet was done for all samples except for sample no. 1, for which no drying was done.

Thereafter diluted phosphoric acid was added. phosphoric acid (85 wt %) was diluted with water. 0.50 or 0.75 g of phosphoric acid (85 wt %) per kg of powder composition was mixed with water. 0, 3, or 10 g per kg powder composition of water was used for the mixing with phosphoric acid. The resulting mixture of diluted phosphoric acid was added to the powder composition and then mixed. This was made in a lab mixer with 1 kg batch size. The mixing time was 2 minutes.

Thereafter a mixture comprising particles of Bi₂O₃ and H₂O was added. D₅₀ for the particles of Bi₂O₃ was 0.9 μm and purchased from 5N Plus. The amount of particles was 1.0 g per kg powder composition. The amount of water was in the interval 0 to 18 g per kg powder composition. Thereafter the powder was mixed 5 minutes in the same mixer.

Subsequently, for all samples except sample no. 6, a drying step was carried out at 120° C. for 120 minutes.

Thereafter an oligomeric diamino-functional silane in accordance with formula (1) R₁[(R₁)ₓ(R₂)_{y}(M2)]ₙOₙ₋₁R₁ was added in an amount of 1.5 g per kg powder composition. The oligomeric diamino-functions silane was Dynasylan® 1146 from Evonik Industries AG, which oligomeric diamino-functional Silina is a preferred embodiment of the present disclosure. In this metal-organic compound, the central metal is silicon (Si).

Thereafter the powder was mixed 2 minutes in the same mixer.

Thereafter 3 g of H₂O was added per kg powder composition. Thereafter the powder was mixed 5 minutes in the same mixer.

After a drying step at 120° C. for 60-120 minutes, the powder compositions were utilized for manufacturing test samples.

The powder composition was mixed with 0.3 wt % lubricant (EBS) based on the total composition. The particulate lubricant was mixed into the coated powder using a paint shaker for 20 seconds followed by a windmill mixer for 10 minutes.

Compaction was done at 800 MPa with a die temperature of 100° C.

Heat treatment of the compacted parts was performed either in a belt furnace (all samples except samples no. 8, 9 and 10) or in a batch furnace (only samples no. 8, 9, and 10), in nitrogen atmosphere with an oxygen level of 5000 ppm.

The belt furnace was operated between 45° and 670° C., with an increasing temperature. The residence time of the compacted parts at above 600° C. was about 20 minutes.

The batch furnace has three zones, the temperature of the first zone was 450° C. with residence time of 30 minutes. The second zone had a temperature of 650° C. and residence time of 25 minutes. Third zone is a cooling zone.

For the finished parts, various properties were measured.

Density was measured using an automated measurement fixture for rings (measuring inner and outer diameter as well as height), and a balance.

Resistivity was measured on the finished magnetic square toroids with the 4-point probe method, with 20 mm distance between measuring points. The specific electrical resistivity was measured on the square toroid samples by a four-point measuring method.

For magnetic measurements, the square toroids were wound with 100 drive and 100 sense turns of resin coated copper wire (diameter 0.63 mm) and measured using a Brockhaus MPG 200D. References: IEC 60404-4 (DC measurements) and IEC 60404-6 (AC-measurements)

Transverse rupture strength, TRS, was measured according to SS-EN ISO 3325:2000, on bars with dimensions of 30×12×6 mm.

The different experiments are summarized in Table 1 below.

Table 1a summarizes added amounts in the different experiments. The amounts are given in g per kg of the powder composition, except for the potassium silicate, where the amount is given in weight percent, wt %.

Table 1b summarizes the different results in the following columns:

A comparable commercial powder is Somaloy® 700HR 5P, the properties of which is given in Table 1b.

It can be seen in Table 1b that the samples are comparable to the reference material, considering all properties listed in the table. It is concluded that the coating works for these relatively coarse particles.

TABLE 1a
Concentrations in g/kg powder composition [g/kg]

| Sam- | (K₂O)_{α}(SiO₂)_{β} | H₃PO₄ (85 wt %) + | Bi₂O₃ | Silane | H₂O |
|---|---|---|---|---|---|
| ple | [wt %] | H₂O[g/kg] | [g/kg] | [g/kg] | [g/kg] |
| 1 | 0.15 | 0.5 + 10 | 1.0 | 1.5 | 3.0 |
| 2 | 0.15 | 0.5 + 10 | 1.0 | 1.5 | 3.0 |
| 3 | 0.15 | 0.5 + 3 | 1.0 | 1.5 | 3.0 |
| 4 | 0.15 | 0.5 + 0 | 1.0 | 1.5 | 3.0 |
| 5 | 0.15 | 0.5 + 10 | 1.0 | 1.5 | 3.0 |
| 6 | 0.15 | 0.5 + 10 | 1.0 | 1.5 | 3.0 |
| 7 | 0.15 | 0.5 + 10 | 1.0 | 1.5 | 3.0 |
| 8 | 0.10 | 0.75 + 10 | 1.0 | 1.5 | 3.0 |
| 9 | 0.10 | 0.5 + 10 | 1.0 | 1.5 | 3.0 |
| 10 | 0.05 | 0.75 + 10 | 1.0 | 1.5 | 3.0 |

In the above table, the experiments 1, 2, 5-7, and 9 are repeat experiments, as well as with a different phosphoric acid concentration, experiments 8 and 10.

It is notable from the experiments that the initial reproducibility is low. Investigations were further conducted (cf. Examples 11 and 12), wherein it was shown that the silicate coated iron-based particles react with the acid component and deposits a partially or fully neutralized silicate onto the surface of an iron-based particle, rather than creating a subsequent layer of a solid mineral acid on the first deposited silicate layer.

In the prior art (c.f. e.g., EP 2252419 B1) phosphoric acid layers were found to form directly on the metallic surface of iron-based particles submitted to a coating procedure using phosphoric acid in acetone.

Rather, as seen in the present experiments, the aqueous acid solution serves to precipitate a partial or fully covering silicate coating on the core iron-based particles.

### Example 2

The iron powder used was an annealed water atomized pure iron powder with an apparent density of 3.4 g/cm³, with D₅₀ in the interval 200-250 μm as measured according to ISO 9276-2:2014. This powder has at least 80 wt % of the core particles in the range 75-380 μm, as measured according to ISO 4497:2020.

The powder was first coated with a coating comprising potassium silicate as defined in Example 1 by addition of a solution of potassium silicate (K12 from Sibelco Nordic AB) in an amount of 0.1 or 0.2 wt % based on the entire powder composition. The powder was then partially dried, using the same method as in Example 1.

Thereafter phosphoric acid was added. 0, 0.4, 0.75, or 1.5 g per kg powder composition of phosphoric acid (85 wt %) was used. The phosphoric acid (85 wt %) was diluted with water. 0, 5, or 10 g per kg powder composition of H₂O was used to dilute the phosphoric acid. The diluted phosphoric acid was added to the powder composition. Phosphoric acid was added to all samples except for sample no. 12, where 0.75 g per kg powder composition of nitric acid (65%) was added and 10 g per kg powder composition of H₂O was used to dilute the nitric acid, and samples no. 17 and 20 where no acid was added. The addition of acid and water was made in a lab mixer with 1 kg batch size. The mixing time was 2 minutes.

TABLE 1b

| | | Max- | Square | Magnetic | Total core | |
|---|---|---|---|---|---|---|
| | Electrical | imal | toroid | Flux | loss for 1 T | |
| Sample | resistivity | perme- | density | @ 10 | and 1 kHz | TRS |
| no. | [μΩm] | ability | [g/cm³] | kA/m [T] | [W/kg] | [MPa] |
| 1 | 24 | Not measured due to a too low resistivity | | | | |
| 2 | 1450 | 626 | 7.53 | 1.59 | 96 | 63 |
| 3 | 330 | 628 | 7.51 | 1.58 | 100 | 56 |
| 4 | 560 | 599 | 7.53 | 1.59 | 96 | 56 |
| 5 | 1880 | 658 | 7.54 | 1.60 | 97 | 65 |
| 6 | 220 | 621 | 7.54 | 1.59 | 99 | 56 |
| 7 | 1570 | 651 | 7.53 | 1.59 | 97 | 64 |
| 8 | 3280 | 625 | 7.54 | 1.60 | 105 | 51 |
| 9 | 1260 | 705 | 7.53 | 1.60 | 104 | 65 |
| 10 | 560 | 770 | 7.48 | 1.61 | 98 | 62 |
| Somaloy | 700 | 600 | 7.50 | 1.57 | 92 | 60 |
| 700HR 5P | | | | | | |

Thereafter a mixture comprising particles of Bi₂O₃ and H₂O was added. D₅₀ for the particles of Bi₂O₃ was 0.9 μm (Submicron from 5N Plus). The amount of particles was 1 g per kg powder composition. The amount of water was 17 g per kg powder composition. Thereafter the powder was mixed 5 minutes in the same mixer.

Thereafter an oligomeric diamino-functional silane was added (Dynasylan® 1146) in an amount of 1.5 g per kg powder composition. Thereafter the powder was mixed 2 minutes in the same mixer.

Thereafter 3 g of H₂O was added per kg powder composition. Thereafter the powder was mixed 5 minutes in the same mixer.

After a drying step at 120° C. for 60-120 minutes, the powder compositions were utilized for manufacturing test samples.

The powder composition was compacted to parts as described in detail in example 1.

Table 2a summarizes added amounts in the different experiments. The amounts are given in g per kg of the powder composition, except for potassium silicate, where the amount is given in wt %.

Table 2b summarizes the different results with the same units as for Table 1b.

A commercial powder with comparable size of the core particles is Somaloy® 700HR 5P, the properties of which is given in Table 2b.

In the experiments reported in Table 2a, for all samples except samples no. 12, 17 and 20, phosphoric acid (85 wt %) was used. For sample no. 12 nitric acid (65%) was used. For sample no. 17 and sample no. 20 no acid was added. The first number indicate the amount of acid and the second amount indicate the amount of water. In the subsequent coatings with B₂O₃ and silane, the concentrations did not vary between experiments. Concentrations in g/kg powder composition.

### Example 3

As an example of using different acids, we note that although samples no. 11 and sample no. 12 were prepared similarly, but with concentrated phosphoric, respectfully concentrated nitric acid. As shown in Table 2b, the use of nitric acid instead of phosphoric acid are comparative in their resulting efficacy, although the total concentration of available protons from a respective acid is significantly higher for phosphoric acid than for nitric acid.

Due to the highly basic nature of silicates, even water appears in the present experiments to act, at least partially, as a reacting acid, providing some benefit to the subsequent coatings.

However, it is clear from the experiments that the addition of a strong, concentrated mineral acid, is superior to simple water addition to particles coated with a silicate.

TABLE 2a
Concentrations in g/kg powder composition [g/kg]

| Sample | (K₂O)_{α}(SiO₂)_{β} | H₃PO₄(85 wt %)/HNO₃(65 |
|---|---|---|
| no. | [wt %] | wt %) + H₂O [g/kg] |
| 11 | 0.10 | 0.75 + 10 |
| 12 | 0.10 | 0.75* + 10 |
| 13 | 0.10 | 1.5 + 10 |
| 14 | 0.20 | 1.5 + 10 |
| 15 | 0.20 | 0.75 + 10 |
| 16 | 0.10 | 0.75 + 10 |
| 17 | 0.20 | — |
| 18 | 0.20 | 0.4 + 5 |
| 19 | 0.10 | 0.75 + 10 |
| 20 | 0.10 | — |

### Example 4

The iron powder used was an annealed water atomized pure iron powder with an apparent density of 3.4 g/cm³, and D₅₀ in the interval 95-100 μm as measured according to ISO 9276-2:2014. The powder has at least 80 wt % of the core particles in the range 75-380 μm, as measured according to ISO 4497:2020, wherein a 100 mesh sieve is 80% within 45 to 150 μm.

The powder composition was coated and made to parts using the same method as detailed in Example 1, however with modified amounts of Bi₂O₃, silane and water.

TABLE 2b

| | | Max- | Square | Magnetic | Total core | |
|---|---|---|---|---|---|---|
| | Electrical | imal | toroid | Flux | loss for 1 T | |
| Sample | resistivity | perme- | density | @ 10 | and 1 kHz | TRS |
| no. | [μΩm] | ability | [g/cm³] | kA/m [T] | [W/kg] | [MPa] |
| 11 | 1360 | 756 | 7.48 | 1.61 | 85 | 50 |
| 12 | 2310 | 673 | 7.49 | 1.61 | 36 | 58 |
| 13 | 24950 | 400 | 7.42 | 1.49 | 93 | 22 |
| 14 | 27470 | 473 | 7.48 | 1.54 | 90 | 48 |
| 15 | 16020 | 595 | 7.48 | 1.57 | 90 | 51 |
| 1.6 | 28380 | 575 | 7.52 | 1.59 | 89 | 42 |
| 17* | 8520 | 512 | 7.44 | 1.55 | 94 | 48 |
| 18 | 21040 | 620 | 7.50 | 1.58 | 91 | 51 |
| 19 | 1220 | 702 | 7.50 | 1.59 | 86 | 42 |
| 20* | 240 | 601 | 7.51 | 1.59 | 90 | 43 |
| Somaloy | 700 | 600 | 7.50 | 1.57 | 92 | 60 |
| 700HR 5P | | | | | | |

Table 4a summarizes added amounts in the different experiments. The amounts are given in g per kg of the powder composition, except for potassium silicate, where the amount is given in wt %.

Table 4b summarizes the different results with the same units as for Table 1b.

The results in Table 4b shows that the amounts of the coating constituents need to be increased compared for these relatively fine powders compared to more coarse powders, in order to achieve a good resistivity. It is concluded that the coating works for these relatively fine particles.

TABLE 4a
Concentrations in g/kg powder composition [g/kg]

| | (K₂O)_{α} | H₃PO₄ (85 | | | |
|---|---|---|---|---|---|
| Sample | (SiO₂)_{β} | wt %) + H₂O | Bi₂O₃ | Silane | H₂O |
| no. | [wt %] | [g/kg] | [g/kg] | [g/kg] | [g/kg] |
| 21 | 0.10 | 0.75 + 10 | 1.0 | 1.5 | 3.0 |
| 22 | 0.10 | 0.75 + 10 | 2.0 | 3.0 | 6.0 |

### Example 5

Green parts of sample no. 23 were produced using the same method as sample no. 21. The green parts were then heat treated in a batch furnace according to Example 1, however the oxygen content was varied between 0 and 50 000 ppm.

Table 5a summarizes added amounts in different experiment. The amounts are given in g per kg of the powder composition, except for potassium silicate, where the amount is given in wt %.

Table 5b summarizes the different results with the same units as for Table 1b. It can be seen in Table 5b that an increased oxygen content in the heat treatment atmosphere gives a higher resistivity. However, when the oxygen level becomes too high (50 000 ppm) the coercivity increases and thus the total core losses.

TABLE 5a
Concentrations in g/kg powder composition [g/kg]

| | (K₂O)_{α} | H₃PO₄ (85 | | | |
|---|---|---|---|---|---|
| Sample | (SiO₂)_{β} | wt %) + H₂O | Bi₂O₃ | Silane | H₂O |
| no. | [wt %] | [g/kg] | [g/kg] | [g/kg] | [g/kg] |
| 23 | 0.10 | 0.75 + 10 | 1.0 | 1.5 | 3.0 |

### Example 6

The iron powder used was an annealed water atomized pure iron powder with an apparent density of 3.2 g/cm³, and D₅₀ in the interval 38-45 μm as measured according to ISO 9276-2:2014. This powder has at least 80 wt % of the core particles in the range 20-75 μm, as measured according to ISO 4497:2020.

The powder composition was coated and made to parts using the same method as detailed in example 1, however with modified amounts of potassium silicate, phosphoric acid, Bi₂O₃ and silane.

Table 6a summarizes added amounts in the different experiments. The amounts are given in g per kg of the powder composition, except for potassium silicate, where the amount is given in wt %.

TABLE 4b

| | | | Square | Magnetic | Total core | |
|---|---|---|---|---|---|---|
| | Electrical | Maximal | toroid | Flux | loss for 1 T | |
| Sample | resistivity | perme- | density | @ 10 | and 1 kHz | TRS |
| no. | [μΩm] | ability | [g/cm3] | kA/m [T] | [W/kg] | [MPa] |
| 21 | 200 | 575 | 7.45 | 1.57 | 88 | 41 |
| 22 | 1390 | 479 | 7.44 | 1.54 | 85 | 38 |

TABLE 5b

| O₂ in | | Max- | Square | Magnetic | Total core | |
|---|---|---|---|---|---|---|
| atmo- | Electrical | imal | toroid | Flux | loss for 1 T | |
| sphere | resistivity | perme- | density | @ 10 | and 1 kHz | TRS |
| [ppm] | [μΩm] | ability | [g/cm3] | kA/m [T] | [W/kg] | [MPa] |
| 0 | 130 | 572 | 7.52 | 1.59 | 79 | 59 |
| 1000 | 190 | 573 | 7.52 | 1.59 | 79 | 60 |
| 3000 | 1140 | 569 | 7.52 | 1.60 | 77 | 58 |
| 5000 | 1440 | 558 | 7.52 | 1.59 | 77 | 57 |
| 10000 | 2880 | 572 | 7.52 | 1.59 | 77 | 59 |
| 20000 | 4660 | 573 | 7.51 | 1.59 | 77 | 60 |
| 50000 | 9820 | 570 | 7.51 | 1.59 | 79 | 67 |

Table 6b summarizes the different results with the same units as for Table 1b.

A commercial powder with comparable size of the core particles is Somaloy® 110i 5P, the properties of which is given in Table 6b.

The results in Table 6b shows that the amounts of the coating constituents need to be increased compared for these fine powders compared to more coarse powders, in order to achieve a resistivity comparable to the reference material. It is concluded that the coating works for these fine particles.

TABLE 6a
Concentrations in g/kg powder composition [g/kg]

| | (K₂O)_{α} | H₃PO₄ (85 wt %)/ | | | |
|---|---|---|---|---|---|
| Sample | (SiO₂)_{β} | HNO₃(65 wt %) + H₂O | Bi₂O₃ | Silane | H₂O |
| no. | [wt %] | [g/kg] | [g/kg] | [g/kg] | [g/kg] |
| 24 | 0.60 | 1.0 + 10 | 3.0 | 1.5 | 3.0 |
| 25 | 0.60 | 2.5 + 10 | 1.5 | 1.5 | 3.0 |
| 26 | 0.30 | 1.0 + 10 | 1.5 | 1.5 | 3.0 |
| 27 | 0.30 | 1.0 + 10 | 3.0 | 1.5 | 3.0 |

### Example 7

A comparative sample not according to the invention was made by repeating the procedure for sample no. 2 but omitting any drying or any removal of water after the application of the potassium silicate. This sample is sample no. 1. In Table 1b the resistivity of the part was only 24 μΩm for sample no. 1 compared to 1450 μΩm for the comparable sample no. 2. Not performing any removal of water at all after application of the silicate did not give satisfactory results.

### Example 8

A comparative example not according to the invention was made by repeating the procedure for sample no. 9. For sample no. 28, an addition of acetone instead of water was made to the acid. The powder was treated after the application of the K silicate. For sample no. 29 the same addition of acetone was made to the acid, but the powder was instead treated before treatment with K silicate. The example is summarized in Table 8a.

The results in table 8b show that acetone is not necessary and satisfactory results are achieved also without use of an organic solvent such as acetone, for depositing an acid coating. It can further be concluded that a phosphate coating under the silicate is not suitable for improving the magnetic properties of the powders of the invention, and that the silicate should be applied directly onto the powder as a first coating.

TABLE 6b

| | | Max- | Square | Magnetic | Total core | |
|---|---|---|---|---|---|---|
| | Electrical | imal | toroid | Flux | loss for 1 T | |
| Sample | resistivity | perme- | density | @ 10 | and 1 kHz | TRS |
| no. | [μΩm] | ability | [g/cm³] | kA/m [T] | [W/kg] | [MPa] |
| 24 | 8680 | 192 | 7.19 | 1.22 | 129 | 61 |
| 25 | 101000 | 185 | 7.16 | 1.20 | 130 | 56 |
| 26 | 1450 | 279 | 7.32 | 1.39 | 120 | 51 |
| 27 | 9250 | 250 | 7.30 | 1.35 | 123 | 55 |
| Somaloy | 18000 | 220 | 7.30 | 1.33 | 108 | 42 |
| 1101 5P | | | | | | |

TABLE 8b

| | | Max- | Square | Magnetic | Total core | |
|---|---|---|---|---|---|---|
| | Electrical | imal | toroid | Flux @ | loss for 1 T | |
| Sample | resistivity | perme- | density | 10 kA/m | and 1 kHz | TRS |
| no. | [μΩm] | ability | [g/cm³] | [T] | [W/kg] | [MPa] |
| 9 | 1260 | 705 | 7.53 | 1.60 | 104 | 65 |
| 28 | 730 | 662 | 7.51 | 1.58 | 106 | 65 |
| 29 | 430 | 639 | 7.51 | 1.58 | 109 | 59 |
| Somaloy | 700 | 600 | 7.50 | 1.57 | 92 | 60 |
| 700HR 5P | | | | | | |

TABLE 8a
Conc. in g/kg powder composition [g/kg]. AcTO—Acetone

| | (K₂O)_{α} | H₃PO₄ (85 wt %) + | | | |
|---|---|---|---|---|---|
| Sample | (SiO₂)_{β} | H₂O/AcTO | Bi₂O₃ | Silane | H₂O |
| no. | [wt %] | [g/kg] | [g/kg] | [g/kg] | [g/kg] |
| 9 | 0.10 | 0.5 + 10 | 1.0 | 1.5 | 3.0 |
| 28 | 0.10 | 0.5 + 10* | 1.0 | 1.5 | 3.0 |
| 29 | 0.10 | 0.5 + 10** | 1.0 | 1.5 | 3.0 |

*Acetone was used instead of H₂O. The addition was made after the K-silicate.
**Acetone was used instead of H₂O. The addition was made before the K-silicate.

### Example 9

A comparative example not according to the invention was made by repeating the procedure for sample no. 11, but the phosphoric acid was replaced with an equal amount of 98% sulphuric acid (sample no. 39) or 60% acetic acid (sample no. 40). As can be seen in table 9, for sample no. 39 rust appeared on the powder and it was concluded that the sulphuric acid was not suitable. For sample no. 40 the resistivity became 416 μΩm instead of 1364 μΩm for the comparable sample no. 11. It was concluded that all acids are not suitable in the process.

TABLE 9

| Sample no. | Electrical resistivity [μΩm] | Rust/No rust |
|---|---|---|
| 11 | 1360 | No rust |
| 39 | — | Rust |
| 40 | 420 | No rust |

### Example 10

A comparative example not according to the invention was made by repeating the procedure as outlined in Example 1, but the powder was dried after applying the phosphoric acid and water mixture.

As can be seen in Table 10, if too much acid was applied the powder would rust. A larger amount of potassium silicate would withstand a larger amount of phosphoric acid before rust would occur.

TABLE 10
Concentration in g/kg powder composition [g/kg].

| | | H₃PO₄ (85 | |
|---|---|---|---|
| | (K₂O)_{α} (SiO₂)_{β} | wt %) + H₂O | |
| Sample no. | [wt %] | [g/kg] | Rust/No rust |
| 30 | 0.05 | 0.75 + 10 | No rust |
| 31 | 0.05 | 0.90 + 10 | Rust |
| 32 | 0.05 | 1.0 + 10 | Rust |
| 33 | 0.10 | 0.75 + 10 | No rust |
| 34 | 0.10 | 1.0 + 10 | No rust |
| 35 | 0.10 | 1.5 + 10 | Rust |
| 36 | 0.10 | 1.65 + 10 | Rust |
| 37 | 0.15 | 1.65 + 10 | No rust |
| 38 | 0.30 | 1.65 + 10 | No rust |

### Example 11

The iron powder used was an annealed water atomized pure iron powder with D₅₀ in the interval 95-100 μm with an apparent density of 3.4 g/cm³. The iron powder was a ferromagnetic powder composition comprising soft magnetic iron-based core particles. The particle size distribution was measured by weighing the different sieve fractions, according to ISO 4497:2020. The average particle size was then calculated according to ISO 9276-2:2014.

The powder composition was coated and made to parts using the same method as detailed in Example 1.

Table 11a summarizes added amounts in the different experiments. The amounts are given in g per kg of the powder composition, except for potassium silicate, where the amount is given in wt %.

Table 11b summarizes the different results with the same units as for Table 1.

TABLE 11a
Concentrations in g/kg powder composition [g/kg]

| | (K₂O)_{α} | H₃PO₄ (85 wt %)/ | | | |
|---|---|---|---|---|---|
| | (SiO₂)_{β} | HNO₃(65 wt %) + H₂O | Bi₂O₃ | Silane | H₂O |
| Sample | [wt %] | [g/kg] | [g/kg] | [g/kg] | [g/kg] |
| 41 | 0.10 | 0 + 10 | 1.0 | 1.5 | 3.0 |
| 42 | 0.10 | 0.085 + 10 | 1.0 | 1.5 | 3.0 |
| 43 | 0.10 | 0.25 + 3 | 1.0 | 1.5 | 3.0 |
| 44 | 0.10 | 0.50 + 0 | 1.0 | 1.5 | 3.0 |
| 45 | 0.10 | 0.75 + 10 | 1.0 | 1.5 | 3.0 |
| 46 | 0.10 | 0.10 + 10 | 1.0 | 1.5 | 3.0 |
| 47 | 0.10 | 0.15 + 10 | 1.0 | 1.5 | 3.0 |
| 48 | 0.10 | 0.085* + 10 | 1.0 | 1.5 | 3.0 |
| 49 | 0.10 | 0.25* + 10 | 1.0 | 1.5 | 3.0 |
| 50 | 0.10 | 0.50* + 10 | 1.0 | 1.5 | 3.0 |

*For samples no. 48, 49 and 50 nitric acid (65%) was used instead of phosphoric acid (85 wt %). The first number indicates the amount of acid, and the second number indicates the amount of water.

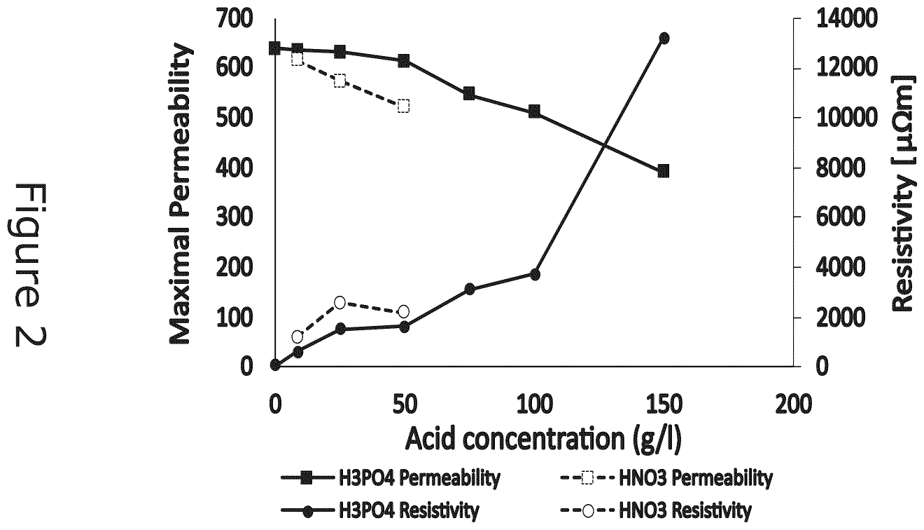

Table 11b shows that the resistivity increases with the addition of phosphoric acid. However, if too much acid is used (Sample no. 47), it has a negative effect on permeability, TRS, and Total core loss, c.f. FIG. 2.

### Example 12

In example 12 the same iron powder is used as was used in Example 11 (denoted #100), as well as in Example 2 (denoted #40), respectively, both having the same first coating, i.e., 0.10 wt % potassium silicate.

1 ml of the acid solution was added to 100 g of dried potassium silicate coated powder in a container, and the mixture was shaken for one minute, and allowed to rest 3 minutes.

Both HNO₃ and H₃PO₄ were used, with varying concentrations.

The powder was then mixed with 200 ml deionized water and after 3 minutes the pH of the water was measured according to DIN 19268. The turbidity was measured according to ISO 7027-1:2016.

FIG. 12a shows that as the pH drops with H₃PO₄ addition, the turbidity increases, and the increase is more distinct for the coarser (#40) powder.

TABLE 11b

| | | | | | Total | |
|---|---|---|---|---|---|---|
| | | | | | core | |
| | | | | | loss | |
| | | | | Magnetic | for | |
| | | Max- | Square | Flux | 1 T | |
| | Electrical | imal | toroid | @ | and | |
| Sample | resistivity | perme- | density | 10 kA/m | 1 kHz | TRS |
| no. | [μΩm] | ability | [g/cm³] | [T] | [W/kg] | [MPa] |
| 41 | 100 | 639 | 7.49 | 1.61 | 86.1 | 68 |
| 42 | 630 | 635 | 7.49 | 1.61 | 76.3 | 59 |
| 43 | 1520 | 632 | 7.50 | 1.61 | 75.4 | 67 |
| 44 | 1640 | 614 | 7.51 | 1.61 | 75.4 | 62 |
| 45 | 3130 | 548 | 7.51 | 1.59 | 76.2 | 59 |
| 46 | 3760 | 511 | 7.50 | 1.58 | 76.9 | 58 |
| 47 | 13200 | 390 | 7.45 | 1.52 | 80.6 | 38 |
| 48 | 1210 | 616 | 7.50 | 1.61 | 75.6 | 72 |
| 49 | 2580 | 574 | 7.48 | 1.59 | 76.7 | 77 |
| 50 | 2170 | 522 | 7.50 | 1.58 | 77.4 | 70 |

The turbidity increase is likely caused by an acid-induced precipitation of silica particles from the potassium silicate coating, demonstrating of the role of the acid treatment, c.f. FIGS. 3 and 4.

As observed, a too low pH destabilizes the potassium silicate coating and causes an unacceptable drop in permeability and TRS in consistence with the presently claimed limits on the acid concentrations.

### Example 13—Surface Examination Using SEM/EDS

In the present example, soft magnetic iron-based core particles were mixed with an aqueous solution of a silicate of the general formula (K₂O)_{α}(SiO₂)_{β} at a β/α ratio of 3.1 to 3.4 and at a concentration of 0.1 wt % according to Example 1 described above. However, no acid treatment was included.

The core particles were examined using a Field Emission Gun Scanning Electron Microscope (FEG-SEM) (Hitachi SU6600) with an Energy Dispersive Spectroscopy detector (Oxford Instruments Ultima Max 65 mm).

Measurements were made at a distance of 10 mm (working distance) using an acceleration voltage of 20 kV at a penetration depth of 1.5 μm and a detection area diameter of 1 μm.

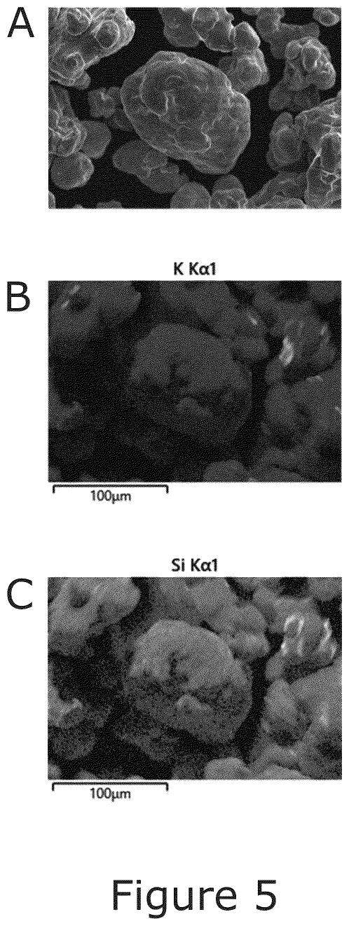

The results are shown in in FIGS. 5 A-C and summarized in Table 13 further below. Herein FIG. 5A shows a SEM image of iron-based core particles coated with silicate. FIG. 5B shows EDS mapping images of the corresponding core particles showing the content of potassium (K) on the surface in light grey to white. It can be observed that the silicate coating differs in thickness over the surface, thus forming thicker portions (patches) having a higher K content than outside the same patches, and thinner portions between the patches.

FIG. 5C shows EDS mapping images of the corresponding core particles showing the content of silicon (Si) on the surface in light grey to white

TABLE 13
EDS point elemental analysis
Measured content [wt %]

| Patches | | | | Between patches | | | |
|---|---|---|---|---|---|---|---|
| | | SiO₂/ | | | | SiO₂/ | |
| | | K₂O | | | | K₂O | |
| K | Si | (mol) | Fe | K | Si | (mol) | Fe |
| 14.4 | 0.56 | 0.11 | 50.7 | 0.17 | 0.48 | 7.9 | 95.5 |

As the SEM/EDS measurement determines the material content not only on the surface of the particles but also to some extent into the bulk particle (the minimum detection depth at 20 kV is about 1.5 μm deep, and about 1 μm in diameter for the EDS point analysis), the difference in measured iron content (Fe) reflects the different thicknesses of the patches and between the patches.

As can be seen from the example, even though potassium silicate deposits at the surface, the resulting coating is highly inhomogeneous and “patchy”, and barely able to cover the iron surface outside the patches.

### Example 14

In the present example, soft magnetic iron-based core particles were mixed with an aqueous solution of a silicate of the general formula (K₂O)_{α}(SiO₂)_{β} at a β/α ratio of 3.1 to 3.4 and at a concentration of 0.1 wt % according to Example 1 described above.

The core particles were examined using a Field Emission Gun Scanning Electron Microscope (FEG-SEM) (Hitachi SU6600) with an Energy Dispersive Spectroscopy detector (Oxford Instruments Ultima Max 65 mm).

Measurements were made at a distance of 10 mm (working distance) using an acceleration voltage of 20 kV.

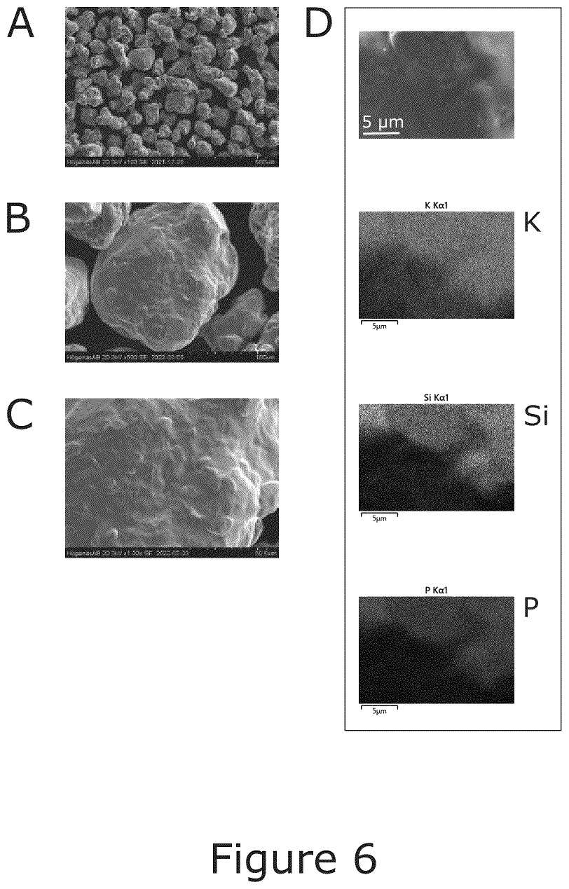

The results are shown in in FIGS. 6 A-C, 7 A-D, and 8 A-B, and summarized in Table 14 further below. Data are averages over at least 4, but in most cases, up to 12 independent EDS measurements.

TABLE 14
EDS analysis on H₃PO₄ and waterglass treated particles

| | Patches | | Si | P | K |
|---|---|---|---|---|---|
| Sample | On | Between | [wt %] | [wt %] | [wt %] |
| Uncoated powder | N.A. | | 0.03 | 0.02 | 0.01 |
| No Acid | X | | 0.56 | 0.01 | 14.4 |
| | | X | 0.48 | 0.01 | 0.17 |
| 8.5 g/L H₃PO₄ | X | | 1.60 | 0.57 | 4.20 |
| | | X | 0.96 | 0.04 | 0.21 |
| 75 g/L H₃PO₄ | X | | 0.75 | 0.55 | 0.47 |
| | | X | 0.51 | 0.06 | 0.14 |

With the weaker acid concentration, the potassium silicate patches look similar to the sample without acid (c.f. FIG. 5), with size up to a few microns.

With the stronger acid concentration, these patches are much smaller (bottom left image), which is consistent with changes in the surface chemistry as also shown in Example 12.

EDS analysis show that the phosphor is predominantly located in the patches/dots together with the potassium. This was taken as being indicative of the patches in fact being nano deposits of K₃PO₄, potentially as nanocrystallites, and not of potassium silicate.

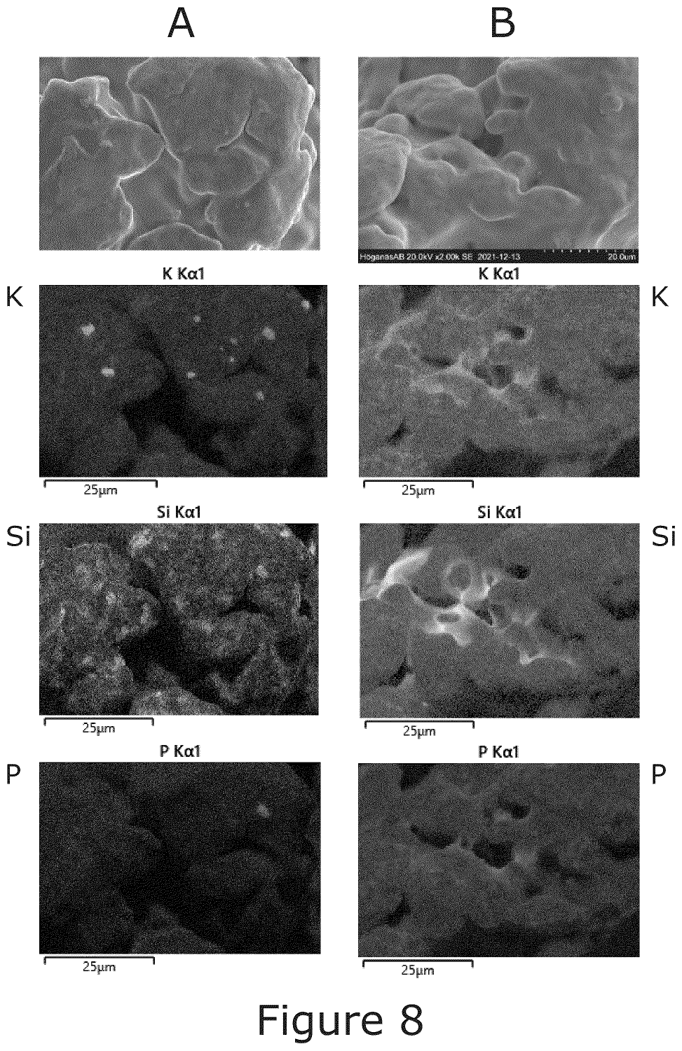

Outside the patches, phosphor is detected at levels higher than the background, about a factor of 2-3 higher, but not as high as for the direct deposits also observed of K₃PO₄. This increase, however, was significant and was observed across all detected positions, consistent with the general intensity increase for phosphor seen in the EDS-images of FIGS. 8 A and B.

This clearly shows that in contrast to the phosphoric acid coating layers formed in the methods of the prior art, the presently coated particles achieve their beneficial properties without phosphoric acid layers being present, but through the combination of the potassium silicate with an insulative water-based coating, or potassium silicate with an insulative water-based coating and interstituent bismuth(III) oxide particles.

However, and advantageously, this increase in the presence of phosphor over the background is proof of the surface having undergone aqueous acid treatment of the potassium silicate with the aqueous phosphoric acid.

In FIG. 6 are shown progressively higher magnifications for uncoated iron-particles, down to 5 μm in FIG. 6D, where EDS for K, Si, and P was performed. Small amounts as shown in Table 14 were found for all three elements, consistent with expected background as no difference between patches and no patches was observed.

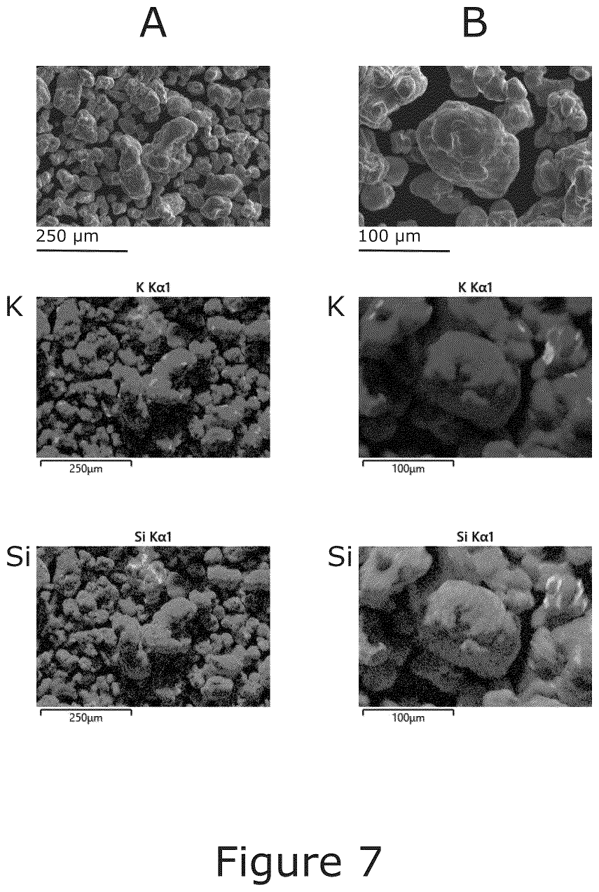

In FIG. 7 are shown potassium waterglass coated iron-based particles, scalebars respectively A: 250 μm and B: 100 μm. As evidenced by the EDS for K and Si when compared to the SEM images, the coatings with potassium water appear homogenous and fully covering (compare with FIGS. 6B and 6C), but patches of thicker waterglass are present (bright patches).

In FIG. 8 are shown results for the waterglass treated particles which were treated at two different phosphoric acid concentrations, A: 8.5 g/l and B: 75 g/l respectively, with EDS performed for K, Si, and P. Notably is the intensity increase of the elemental signals in dependence on the acid treatment, consistent with the results obtained under Example 12.

Based on the herein presented experiments it was possible to conclude that the aforementioned chemical change in the presence of aqueous acid involves at least partial reaction of the deposited silicates to form silica as the first coating. Further, it was possible to conclude that under optimal reaction conditions, a full conversion of silicate to silica takes place under influence of the aqueous acid.

Based on the herein presented experiments, it is possible to define an internal standard comprising a test for when silicates of the first coating (12a) has been treated with an aqueous acid, such as with preferably phosphoric acid or nitric acid, and most preferably with phosphoric acid, namely that the silicate covered surface shall present a significant increase in a detected level of at least one element characteristic of the aqueous acid used, when the silicate covered surface is measured prior and after aqueous acid treatment, the detection being by Energy Dispersive Spectroscopy (EDS), wherein measurements are made at a distance of 10 mm (working distance) using an acceleration voltage of 20 kV, a penetration depth of 1.5 μm and a detection area diameter of 1 μm, and wherein a detection result for a detected level of a characteristic element is an average of at least 4 independent detections.

Since the coatings of Soileau et al. do not rely on further chemical modification, detection of an increased level of at least one element characteristic of the aqueous acid used is a sensitive measure of distinguishing the present coatings from the coatings of Soileau et al.

From the experiments it was observed that the acid treatment and the associated decrease in pH results in a precipitation of nano silica that facilitates the distribution of silicate to full coverage, as evidenced by the turbidity measurements (c.f. Example 12 and FIGS. 3 and 4).

Accordingly, the acid treated first coating is a covering silicate coating.

It was observed that the acid treatment causes an enrichment of cations at the silicate surface (in the experiments potassium ions (K+) that will seek up unreacted silicate during powder processing (in the experiments stirring) and form nanosized patches. These patches have a low ratio of (SiO₂/K₂O) relative to the background coating between the patches. The patches ultimately, as the acid concentration is increased, become smaller and well distributed, contributing to the beneficial effects observed for the tribology (internal lubrication and protection from cold welding during compaction), eventually completing a full transition from silicate to silica.

Accordingly, in an embodiment, the first coating is a silica-coating.

As further observed in the experiments with phosphoric acid, too much acid eventually, after full transformation of the silicate to silica, further reacts with potassium thereby forming the observed K₃PO₄ nanocrystallites.

Thereby it is possible to define an internal test for the reaction of silicate to silica by comparing an EDS-measured content, as defined above, of an alkali metal ion (in the experiments potassium (K)) in patches after coating and before acid treatment with the amount of alkali metal ion after acid treatment, wherein a decrease of alkali metal ion is conclusive for the reaction from silicate to silica, and absence of further alkali metal ion reduction after a first reduction is conclusive for the complete reaction of silicate present on the coated core particles into silica.

The measured reductions on the patches (c.f. Table 14) were respectively by factors of 14.4/4.2≈3.4 (8.5 g/l H₃PO₄) and 14.4/0.47≈30.6 (75 g/l H₃PO₄) for the partially reacted and the fully reacted surface.

### Example 15

In the present example, soft magnetic iron-based core particles were mixed with an aqueous solution of a silicate of the general formula (K₂O)_{α}(SiO₂)_{β} at a β/α ratio of 3.1 to 3.4 and at a concentration of 0.1 wt % according to Example 1 described above. Further, particles of bismuth(III) oxide were added to the silicate coated particles.

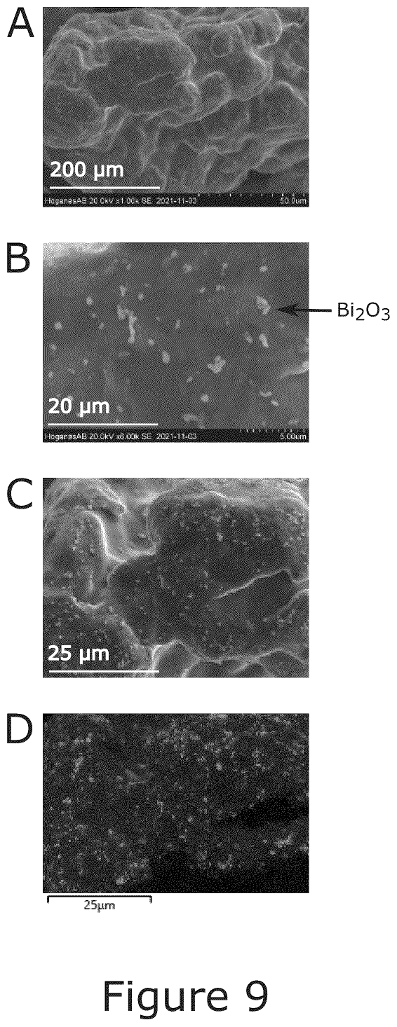

As shown in FIG. 9, at the chosen bismuth(III) oxide particle concentration, these distributed without a recognizable pattern over the silicate coated particles, consistent with individual particle deposition from dilute solution.

### Example 16

The particles of Example 15 having a potassium silicate coating and surface adhered bismuth(III) oxide were subsequently coated with Dynasylan® in accordance with the procedure of Example 1.

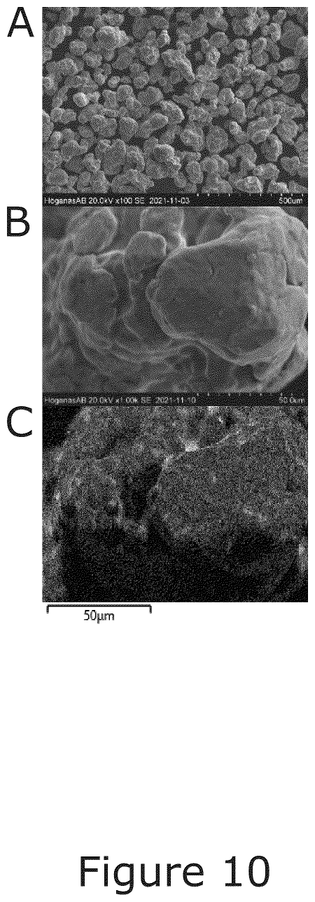

As seen in FIG. 10, the bismuth(III) oxide particles become indistinguishable under the Dynasylan-coating. The EDS indicates a uniform and substantially complete coating, however since EDS is only sensitive to the Si in the Dynasylan molecules, the measured signal will contain some contribution from the underlying silicate due to the penetration depth of the EDS-beam.

### CLOSING COMMENTS

Although the present invention has been described in detail for purpose of illustration, it is understood that such detail is solely for that purpose, and variations can be made therein by those skilled in the art in practicing the claimed subject matter, from a study of the drawings, the disclosure, and the appended claims.

The term “comprising” as used in the claims does not exclude other elements or steps. The indefinite article “a” or “an” as used in the claims does not exclude a plurality. A reference sign used in a claim shall not be construed as limiting the scope.

1. A ferromagnetic powder composition comprising soft magnetic iron-based core particles,
wherein at least 80 wt % of the core particles has a particle size distribution within the range from 20 to 1000 μm, measured according to ISO 4497:2020,
wherein the surface of the core particles is at least partially coated with a first coating comprising an aqueous silicate of the general formula (M₂O)_{α}(SiO₂)β,
wherein α is moles of M₂O, β is moles of SiO₂, and the β/α molar ratio is in the interval from 0.5 to 4.1,
wherein M is selected from Li, Na, and K,
wherein the first coating is in direct contact with a surface of the core particles of the ferromagnetic powder,
wherein the silicate is present in the amount of from 0.02 to 1.0 wt % calculated based on the total weight of the ferromagnetic powder composition, and
wherein the first coating is acid treated with an aqueous acid after forming the first coating on the iron-based core particles.

2. The ferromagnetic powder composition according to claim 1, wherein M is potassium.

3. The ferromagnetic powder composition according to claim 1, wherein the aqueous acid is either aqueous phosphoric acid or aqueous nitric acid.

4. The ferromagnetic powder composition according to claim 1, wherein the aqueous acid is aqueous phosphoric acid.

5. The ferromagnetic powder composition according to claim 1, where on the first coating bismuth(III) oxide particles are deposited, the bismuth(III) oxide particles having a D₅₀ measured according to SS-ISO 13320-1 in the interval from 0.1 to 10 μm.

6. The ferromagnetic powder composition according to claim 1, wherein the core particles further comprise a second coating, the first coating on a core particle located between the core particle and the second coating, the second coating formed from at least one insulative water-based organic molecule suitable for depositing at least as a monolayer on the first coating.

7. The ferromagnetic powder composition according to claim 6, wherein the at least one insulative water-based organic molecule suitable for depositing at least as a monolayer on the first coating comprises:
at least one metal-organic compound having the following general formula:
R₁[(R₁)ₓ(R₂)_{y}(M2)]ₙOₙ₋₁R₁
wherein M2 is selected from the group consisting of Si, Ti, Al, and Zr;
O is oxygen;
R₁ is a hydrolysable group;
R₂ is an organic moiety, and wherein at least one R₂ contains at least one amino group;
wherein n is the number of repeating units being an integer between 1 and 20;
wherein x is 0 or 1; and
wherein y is 1 or 2.

8. The ferromagnetic powder composition according to claim 7, wherein M2 is silicon.

9. The ferromagnetic powder composition according to claim 1, wherein at least 80 wt % of the core particles is in the range from 20 to 75 μm, as measured according to ISO 4497:2020.

10. The ferromagnetic powder composition according to claim 1, wherein at least 80 wt % of the core particles is in the range from 45 to 150 μm, as measured according to ISO 4497:2020.

11. The ferromagnetic powder composition according to claim 1, wherein at least 80 wt % of the core particles is in the range from 75 to 380 μm, as measured according to ISO 4497:2020.

12. The ferromagnetic powder composition according to claim 1, wherein the silicate is present in the ferromagnetic powder composition in the amount from 0.05 to 1.0 wt %, calculated based on the total weight of the ferromagnetic powder composition.

13. The ferromagnetic powder composition according to claim 1, wherein potassium silicate is present in an amount of from 0.1 to 0.6 wt %, calculated based on the total weight of the ferromagnetic powder composition.

14. The ferromagnetic powder composition according to claim 1, wherein the β/α molar ratio of the silicate is in the interval from 2.5 to 4.1.

15. The ferromagnetic powder composition according to claim 5, wherein D₅₀ for the bismuth(III) oxide particles measured according to SS-ISO 13320-1 is in the interval from 0.5 to 2 μm.

16. The ferromagnetic powder composition according to claim 5, wherein the bismuth(III) oxide particles are present in an amount from 0.05 to 0.30 wt % calculated based on the total weight of the ferromagnetic powder composition.

17. The ferromagnetic powder composition according to claim 5, wherein the bismuth(III) oxide particles are present in an amount of from 0.10 to 0.30 wt % calculated based on the total weight of the ferromagnetic powder composition.

18. The ferromagnetic powder composition according to claim 5, wherein the bismuth(III) oxide particles are present in an amount of from 0.10 to 0.25 wt %, and the metal-organic compound is present in an amount of from 0.10 to 0.25 wt % calculated based on the total weight of the ferromagnetic powder composition.

19. The ferromagnetic powder composition according to claim 7, wherein the metal-organic compound is present in an amount of from 0.15 to 0.30 wt %, calculated based on the total weight of the ferromagnetic powder composition.

20. The ferromagnetic powder composition according to claim 7, wherein potassium silicate is present in an amount of from 0.10 to 0.30 wt %, wherein the bismuth(III) oxide particles are present in an amount of from 0.10 to 0.20 wt %, and wherein the metal-organic compound is present in an amount of from 0.10 to 0.20 wt %, calculated based on the total weight of the ferromagnetic powder composition.

21. The ferromagnetic powder composition according to claim 7, wherein the metal-organic compound is selected from the group consisting of alkoxy-terminated amino-silsesquioxanes, amino-siloxanes, oligomeric 3-aminopropyl-alkoxy-silane, 3-aminopropyl-propyl-alkoxy-silane.

22. The ferromagnetic powder composition according to claim 7, wherein the metal-organic compound is selected from the group consisting of N-aminoethyl-3-aminopropyl-alkoxy-silane, and N-aminoethyl-3-aminopropyl-methyl-alkoxy-silane.

23. A method for coating soft magnetic iron-based core particles with a water-silicate solution, the method comprising the sequential steps of:
a. providing soft magnetic iron-based core particles,
b. contacting the soft magnetic iron-based core particles with a first aqueous mixture comprising a silicate of the general formula (M₂O)_{α}(SiO₂)_{β}, wherein
M is selected from Li, Na, and K,
α is moles of M₂O, β is moles of SiO₂, and wherein the β/α molar ratio is in the interval from 0.5 to 4.1,
thereby obtaining a first coating at least partially covering the core particles which is in direct contact with a surface of the core particles,
c. removing at least a part of the water,
d. reacting the silicate coated soft magnetic iron-based core particles with an aqueous acid,
wherein
the silicate is present from 0.02 to 1.0 wt % calculated based on a total weight of the at least partially coated soft magnetic iron-based core particles.

24. The method for coating soft magnetic iron-based core particles with a water-silicate solution according to claim 23, wherein the M is potassium.

25. The method for coating soft magnetic iron-based core particles with a water-silicate solution according to claim 23, wherein the aqueous acid is phosphoric acid or nitric acid.

26. The method according to claim 23, wherein steps b) and c) are repeated at least once.

27. The method according to claim 23, wherein from 0.05 to 0.5 wt % of the silicate calculated based on the total weight of the ferromagnetic powder composition is added in step b).

28. The method according to claim 23, wherein the β/α molar ratio of the silicate is in the interval from 2.5 to 4.1.

29. A method for obtaining a ferromagnetic powder composition comprising coating a powder comprising at least 80 wt % soft magnetic iron-based core particles having a particle size distribution within the range from 20 to 1000 μm, measured according to ISO 4497:2020 using a method according to claim 23, prior to a subsequent process step of drying and isolating the ferromagnetic powder composition.

30. A method obtaining a ferromagnetic powder composition according to claim 29, wherein the method further comprises prior to a subsequent process step of drying and isolating the ferromagnetic powder composition, the additional sequential steps of:
e. optionally, contacting the at least partially coated soft-magnetic iron-based core particles from step c) with bismuth(III) oxide particles, wherein D₅₀ for the bismuth(III) oxide particles as measured according to SS-ISO 13320-1 is in the interval from 0.1 to 10 μm,
f. optionally removing at least a part of the water, and
g. contacting particles with a metal-organic compound having the general formula:
R₁[(R₁)ₓ(R₂)_{y}(M2)]ₙOₙ₋₁R₁
wherein M2 is selected from the group consisting of Si, Ti, Al, and Zr;
O is oxygen;
R₁ is a hydrolysable group;
R₂ is an organic moiety and wherein at least one R₂ contains at least one amino group;
wherein n is the number of repeating units being an integer between 1 and 20;
wherein x is 0 or 1;
wherein y is 1 or 2.

31. The method according to claim 29, wherein M2 is silicon.

32. The method according to claim 29, wherein step e) is included.

33. The method according to claim 29, wherein step f) is included.

34. The method according to claim 29, wherein both steps e) and f) are included

35. The method according to claim 29, wherein at least 80 wt % of the provided core particles is in the range from 20 to 75 μm, as measured according to ISO 4497:2020.

36. The method according to claim 29, wherein at least 80 wt % of the core particles is in the range from 45 to 150 μm, as measured according to ISO 4497:2020.

37. The method according to claim 29, wherein at least 80 wt % of the core particles is in the range from 75 to 380 μm, as measured according to ISO 4497:2020.

38. The method according to claim 29, wherein D₅₀ for the bismuth(III) oxide particles as measured according to SS-ISO 13320-1 is in the interval from 0.5 to 2 μm.

39. The method according to claim 29, wherein bismuth(III) oxide particles are present in an amount from 0.05 to 0.30 wt %, calculated based on the total weight of the ferromagnetic powder composition.

40. The method according to claim 29, wherein the silicate is present in an amount in the range from 0.10 to 1.0 wt %, calculated based on the total weight of the ferromagnetic powder composition.

41. The method according to claim 29, wherein the metal-organic compound is present in the range from 0.15 to 0.30 wt %, calculated based on the total weight of the ferromagnetic powder composition.

42. The method according to claim 29, wherein the bismuth(III) oxide particles are present in an amount of from 0.10 to 0.25 wt %, and wherein the metal-organic compound is present in an amount of from 0.10 to 0.25 wt % calculated based on the total weight of the ferromagnetic powder composition.

43. The method according to claim 29, wherein the silicate is a potassium waterglass, and is present in an amount from 0.10 to 0.30 wt %, wherein the bismuth(III) oxide particles are present in an amount from 0.10 to 0.20 wt %, and wherein the metal-organic compound is present in an amount from 0.05 to 0.20 wt %.

44. The method according to claim 29, wherein the metal-organic compound is selected from the group consisting of alkoxy-terminated amino-silsesquioxanes, amino-siloxanes, oligomeric 3-aminopropyl-alkoxy-silane, 3-aminopropyl-propyl-alkoxy-silane.

45. The method according to claim 29, wherein the metal-organic compound is selected from the group consisting of N-aminoethyl-3-aminopropyl-alkoxy-silane, and N-aminoethyl-3-aminopropyl/methyl-alkoxy-silane.

46. A method for manufacturing an object from a ferromagnetic powder composition according to claim 29, the method comprising:
h. taking the ferromagnetic powder composition from step g., and mixing the ferromagnetic powder composition with at least one lubricant,
i. optionally, pre-heating the die to a temperature below the melting temperature of the added particulate lubricant,
j. compacting the composition in a die at a compaction pressure in the range from 300 to 2000 MPa,
k. ejecting the obtained green body, and
l. heat-treating the green body in a non-reducing atmosphere, at a temperature in the range from 300 to 800° C.
